(19) United States
(12) Patent Application Publication
(10) Pub. No.: US 2021/0093947 A1
(43) Pub. Date: Apr. 1, 2021

(54) Programmable Gaming Device, and Method of Operating such Gaming Device

(71) Applicant: Alon Adda, Binyamina (IL)

(72) Inventor: Alon Adda, Binyamina (IL)

(21) Appl. No.: 16/980,866

(22) PCT Filed: Mar. 6, 2019
(86) PCT No.: PCT/IL2019/050243

§ 371 Date: Sep. 15, 2020

Related U.S. Application Data
(60) Provisional application No. 62/659,149, filed on Apr. 18, 2018.

(51) Int. Cl. A63F 9/24; G06F 3/041; G06F 3/16

(52) U.S. Cl. CPC A63F 9/24; G06F 3/041; G06K 9/00013; G06F 3/165; G06F 3/167

(57) ABSTRACT

Programmable gaming device, and method of operating such gaming device. The gaming device includes a set of illumination units, each one of them capable of selectively illuminating at different colors; as well as a set of touch-sensitive surfaces or sensors, each one of them being temporarily and non-fixedly associated with one or more of the illumination units. A processor enforces a game logic selected from a bank of rules stored in a memory unit of the gaining device. Optionally, sound is generated via audio speakers, and one or more human users can play various games through the gaming device. Optionally, the gaming device is implemented as table top, or as a table having a single central leg or multiple supporting legs.

### CROSS-REFERENCE TO RELATED APPLICATIONS

This patent application claims priority and benefit from U.S. 62/659,149, filed on Apr. 18, 2018, which is hereby incorporated by reference in its entirety.

### FIELD

The present invention is related to electronic games.

### BACKGROUND

Millions of people utilize mobile and non-mobile electronic devices, such as smartphones, tablets, laptop computers and desktop computers, in order to perform various activities. Such activities may include, for example, browsing the Internet, sending and receiving electronic mail (email) messages, taking photographs and videos, engaging in a video conference or a chat session, or the like.

Some electronic devices are utilized for playing games. For example, a user may play games such as “Pac-Man” or “Space Invaders” on his computer or smartphone, or via a stand-alone arcade game (e.g., a coin-operated gaming machine having a joystick and push-buttons).

### SUMMARY

The present invention may include, for example, a programmable gaming device or electronic platform for games and/or other purposes (e.g., recreational, leisure, educational, music-related, artistic, or the like), as well as methods of operating and/utilizing it.

In some embodiments, the platform is a surface having embedded touch sensors and LEDs (or other illumination units), and includes an electronic system to operate the functions of the device, and internal or external loudspeakers or audio speakers or audio output units.

Optionally, a vertical pole or other structure may be mounted on (or connected to, or connected through) the flat surface, such as at the center of the flat surface and being generally perpendicular to it; the additional or optional pole may have additional LEDs (or other illumination units) which add visualized functionality to the device, and/or may optionally include additional audio speaker. The large surface of the gaming device may be placed on a table or floor or countertop or other flat or generally-flat surface or area or object, or may be attached or connected to supporting legs which transform it into a table or a gaming table.

The device may be pre-programmed (e.g., at a manufacturing facility) or may be dynamically programmed (e.g., by an end-user or an administrator) to have one or more particular functionalities, which can be selected when the device is operate; or to operate in accordance with a particular set of rules or pattern or gaming scenarios or gaming rules.

The gaming device may be suitable for 1 to 12 players; some implementations may be particularly tailored for two players, for three players, for four players, for a single player, or for other number of players. The games that can be played via the device may be suitable for players of all ages, or may be tailored to a particular age or age-range or age group; and/or may enable an interactive experience which is not necessarily limited by age differences of the players, such that players of 6 and 20 and 50 and 70 years old may be able to play together using the same gaming device.

The functionalities of the device may vary from action games, which require fast movement and responses, through thinking games and tactic or strategy games, as well as a playable musical instrument or a device that provides a visual—audio experience for other purposes (e.g., educational, artistic, or the like).

The present invention may comprise a programmable electronic platform for games and for playing music. The platform may be a flat surface, with embedded touch-sensors and LEDs (or other illumination units), and includes an electronic system to operate the functions of the gaming device, and internal or external loudspeakers or audio speakers. Various multiplayer games may be implemented using the touch-sensors and illumination indicators and audio output units of the gaming device, and particularly, various multi-player games which require the physical co-location or co-presence and active movement of multiple players, unlike conventional arcade or video games.

The present invention may provide other and/or additional benefits or advantages.

### BRIEF DESCRIPTION OF THE DRAWINGS

FIG. 1A is a schematic illustration of a system, in accordance with some demonstrative embodiments of the present invention.

FIG. 1B is a schematic illustration of a playing surface, in accordance with some demonstrative embodiments of the present invention.

FIG. 1C is a schematic perspective illustration of a system without the central pole, in accordance with some demonstrative embodiments of the present invention.

FIG. 1D is a schematic perspective illustration of a system with the central pole, in accordance with some demonstrative embodiments of the present invention.

FIG. 1E is a schematic perspective illustration of a system surrounded by human players, in accordance with some demonstrative embodiments of the present invention.

### DETAILED DESCRIPTION OF SOME DEMONSTRATIVE EMBODIMENTS

The present invention includes a programmable gaming device or gaming system, as well as methods of operating and/or using and/or configuring such gaming devices or gaming systems.

Some portions of the discussion herein may relate, for demonstrative purposes, to one implementation which may be called “Table 44” or “Table44” or “Table For Four”, which is a demonstrative implementation of an electronic physical game that may be used by four (or more, or less) players; however, the present invention further includes other implementations which are directed to be used by a single player or by other number(s) of players, and not necessarily four players, and not necessarily implemented as a table or as a table-based gaming device.

Some portions of the discussion herein may relate, for demonstrative purposes, to a “gaming” device or a “gaming” system; however, embodiments of the present invention may comprise devices and systems that are not necessarily regarded as “games” or as “gaming”; for example, they may be or may comprise (or may be regarded or defined as) entertainment devices or system, social interaction devices or systems, social activity or group activity devices or systems, recreational or leisure devices or systems, educational devices, business-related devices (e.g., utilized by an organization or enterprise or group of people for team-building), memory training or memory enhancing devices or systems, physical ability enhancing (or training) devices or systems, devices utilized to enhance focusing or concentrating of user(s), artistic devices, devices utilize to practice or to exhibit art or music or visual art or audible art, or the like. Accordingly, the “gaming” device(s) discussed herein may further comprise the other above-mentioned types of devices or systems, and/or may be utilized to achieve a variety of goals.

The present invention may include electronic games, and particularly, physical electronic games that do not include (or, that exclude) a screen or a touch-screen or a monitor or a display unit. The present invention may include a stand-alone leisure or recreational gaming device, structured or suitable for social use or for entertainment purposes by a single user or by multiple concurrent users, requiring the physical presence of one or more players, and not requiring (and not utilizing, and not being connected or coupled to) a personal computer, a gaming console, or any portable device having a screen or a touch-screen. Use of the gaming device of the present invention may entails physical movement of the player(s), as well as physical gestures performed by the player(s); and the gaming device of the present invention is not operated by (and does not comprise, and does not require, and is not coupled to or connected to) a gaming controller or a joystick or a mouse or a touch-screen.

In some embodiments, the gaming device is implemented in the form of a table, around which players stand (or sit) and play using their hands (or fingers, or palm, or arm, or elbow, or other suitable body organs or body parts if desired). Players may sit around the gaming device, or stand around it; or even, in some implementations, players may be required to walk or jump or run or encircle around the gaming device (e.g., in order to physically reach and/or actuate a remote input-unit of the gaming device. The device of the present invention may be implemented a programmable platform, which can be programmed or pre-programmed (e.g., before installation and/or after installation) to implement a variety of functionalities or rules or gaming rules or playing rules.

The Applicant has realized that conventional electronic games (e.g., video games that are played via a computer or a gaming console) require little or no physical movement (e.g., aside from the use of fingers), and may cause social detachment. Although multiplayer Internet-based games exist, communication among players is limited to (and/or is dependent upon) the use of electronic means (such as computer screen, microphone and headphones) and does not entail the physical presence of players in a common space or other real-life immediate and proximate interaction among players.

The Applicant has further realized that most computer games or video games are typically designed for defined age groups; and they do not encourage participation of players of diversified ages who play the same game together (or, against each other).

The Applicant has also realized that as computer games gained popularity and as smartphones and tablets became part of everyday activities, physical games have lost popularity, mainly among children, teenagers, and young people.

The gaming device of the present invention is structured to uniquely bridge between computerized video games and classic social board games, allowing the players to enjoy both the excitement and visual effects of a computerized game, along with the advantages of social interactive games and social activity or group activity among users who are in immediate proximity to each other within the same venue or location; and without the need to utilize a touch-screen or multiple touch-screens in which the same screen operates to generate visual output and to capture touch-based input; and without the need to connect the device to a computer or to a gaming console, or to a set of wireless or wired gaming controllers or joysticks or other detached or separate input units.

The gaming device of the present invention is an exciting and interactive electronic game which generates and utilizes visual lights and audible sounds, and additionally, requires physical presence and movement of players and their bodies (beyond the mere movement of their fingers), thereby allowing the player to enjoy a real-life experience that cannot be reconstructed by a touch-screen and/or a manual game controller or joystick. The gaming device of the present invention further entails, in some embodiments, the physical and proximate presence of a number of players around it, thereby bringing back the social factor, which diminished with the development of video games and the disappearance of electronic games from social gathering places as well as the drastic decline in the popularity of board games.

Additionally, the gaming device of the present invention, particularly when implemented as gaming table or as a tabled-based gaming device, requires the multiple players to surround or encircle the table and thus face each other (partially or entirely); in contrast with, for example, two players who play a video game and stand parallel to each other staring at the same direction of a television screen when playing a conventional video game for two players, focusing and looking at the television screen and not seeing the movements or gestures or body-language of the other player(s). In contrast, the gaming device of the present invention may allow a player to see both the gaming device and other players, who are standing (or sitting) across from him or near him yet directed towards him (partially or entirely), thereby increasing the social interaction among players, reducing the feeling of solitude of a player, and enabling each player to capture or notice the body-language and gestures of other players as well as their reactions to the game's progress.

In contrast to the board games and electronic games in their original form, the gaming device of the present invention may be uniquely implemented as a programmable device, which allows for one gaming device to carry or support or execute multiple different games, and/or to function as a musical instrument and an artistic visual device as well, based on the programmed functionality. Once programmed (or pre-programmed as part of its production process), the gaming device of the present invention operates as an independent, stand-alone, unmediated device which does not require the use of a computer or screen or touch-screen or gaming controller(s) or joysticks, and may function as a stand-alone game and/or musical instrument and/or artistic visual device requiring only electric power (e.g., from an external power source, an internal power source, a batter, a wall-based electric socket or outlet, or the like).

Some embodiments of the present invention may encourage social interaction and physical movement, two features that are lacking in popular electronic games or video games.

In addition to these two features, the device of the present invention, being an electronic game, is rich with audio sounds and visual sights in the form of LED or OLED lights (or other illumination units), which are interactive and responsive to the players' actions, and are programmable according to need in order to accommodate and enable various playing rules, gaming rules, or other operational schemes or patterns.

The gaming device of the present invention may bring added value to places where people tend to gather and desire social interaction; such as, bars, cafes, visitor centers, recreational areas at places of business or entertainment, sporting venues, social events, as well as public parks, indoor facilities, outdoor facilities (e.g., the gaming device may be powered via a generator or via sufficient batteries or power cells), or the like.

The gamin device's size is such that it allows for several people to play concurrently or simultaneously in comfort, without necessarily bumping each other and/or touching each other and/or obstructing each other, and such that each player (in some implementation) may have a non-obstructed view of the entirety of the gaming device and/or of all the other players. The gaming device may be pre-programmed or may be dynamically programmed or updated with various games or gamin rules or gaming schemes, some of which may require tapping the sensors with hand movements only, whereas others may require additional physical movement, such as walking and/or running and/or jumping around the gaming device in order to reach the sensor that the player wants to tap. In some embodiments, the gaming device may allow cooperation among players, or the formation of “teams” of players which may play against each other.

The input mechanism used in the gaming device may comprise multiple touch sensors or touch-based sensors. Each touch sensor may be implemented as a touchable element or piece or tile, made of metal or glass or plastic or other suitable material; having the same shape and size and/or having different or varying shapes and/or sizes. The touch sensors are embedded into or onto the upper surface of the gaming device. The touch sensors inform or signal to the processing unit when they are touched; and in some embodiments, a user need not exert pressure, but rather, a slight touch may be sufficient to actuate the touch-based input sensor.

In some embodiments, the touch sensors are not necessarily capable of identifying the touching party or determining the identity of the touching person, but rather, they operate identify the occurrence of a touch event and to signal to the processing unit the occurrence of the touch event as well as the location and/or timing of the sensed touch event, and may further sense and inform the processing unit about simultaneous touches that were concurrently registered or captured on two or more sensors. In other embodiments, optionally, some or all of the touch-based sensors may optionally incorporate in them a fingerprint scanner or imager and a fingerprint analysis unit, which may enable the gaming device to further determine the identity of the user who tapped or touched each touch-sensor, for example, based on an initial registration process or enrollment process in which each player enrolls or registers his fingerprint(s) with the gaming device to enable such identification; and this feature may enable the gaming device to implement unique gaming rules, for example, such that a first player would be required to run around the gaming device and touch different sensors at particular time points, whereas a second player may be stationary and may operate only a particular subset of the touch sensors, or other suitable gaming schemes which may optionally take into account also the identity of the player that registered the touch event and/or whether such player belongs to a particular team or group of players.

In addition to the touch-based sensors which are input units, the top surface of the gaming device further contains or embeds therein or incorporate therein multiple LEDs or OLEDS (Organic LEDS) or other illumination units, which are the visual output of the gaming device. In some embodiments, such illumination units are implemented or displayed with stripes or polygons of different shapes (e.g., rectangles, triangles, squares, pentagons) or may have other suitable shapes (e.g., circles, ovals, snake shaped, animal shaped, food shaped, or the like).

The gaming device allows a game to be played on its upper surface, which is a flat and smooth or generally-smooth surface. In some embodiments, an optional LED covered pole or rod or pillar or cylinder is further located in or at or near the center of the surface, extending upwardly and perpendicularly to the top surface of the gaming device. The LEDs of that central pole may display support information and/or or other information related to the game mode selected and its functions and/or may display or may indicate other game-related information, such as current score(s) or ranking(s) of players, indications of the time elapsed or time remaining, indications of the correct and/or incorrect touch-events that were performed, indications of the remaining number of touch-events that need to be completed, or the like. In some implementations, for example, the display of LEDs on the central pole may indicate the selected game mode, the current score(s) or ranking(s) of players, the current winner or the final winner, and/or other suitable data. In some embodiments, the central pole operates only as a display unit or an output unit, and does not include any input units or input sensors or touch sensors, and players are not required to touch it or to move it or to tap it. The central LED pole may be detachable or removable, and the gaming device may be configured to function in its absence, depending on the selected game mode and its function.

The central pole, similar to the LEDs on the surface of the gaming device, serves as an output unit for conveying output information to the players. The information that the players receive from it may vary in accordance with the game mode or operational mode selected, and includes (but is not limited to), the following data or a combination thereof: (1) Specifying the mode/game currently played, using letters drawn on the pole; (2) Display of LEDs in animated movement, allowing the representation of a static or moving logo or text; (3) A timer or a counter represented by the movement of LEDs on the pole; (4) Representing each participant (and/or his touch events) via a unique color; (5) Indicating the progress in the game, such as the general progress or the individual progress of each participant, or indicating the progress of teams or groups from the current players, displayed in various ways (e.g., each participant may be represented by a line in his color, which climbs upward (or descends downward) in accordance with the participant's progress in the game, or in accordance with reaching certain gaming milestones; (6) Indicating the score of the participant who is currently playing (represented by a color), or of some or all of the participants (e.g., using color codes); (7) Visually announcing and presenting the winning color. Other suitable visual functions may be assigned to or programmed to the central pole and its LEDs or illumination unit. In some embodiments, the central pole may comprise dozens or even hundreds of discrete LED units, and an illumination controller may selectively activate and/or deactivate them in a particular illumination pattern, thereby enabling the central pole to visually convey information that comprises digits, letters, other characters, animation effects, or the like.

In some embodiments, optionally, the central pole may further comprise audio speakers able to output also tunes or music or tones or audible sounds or messages (e.g., “On your marks” or “Game over” or “We have a winner”). In some embodiments, optionally, the central pole may optionally comprise one or more touch-based sensors, and the gaming rules may define that a player or some players may be required to touch or tap the central pole as part of the game being played, although such feature may be optional and need not necessarily be implemented in all gaming devices of the present invention.

In some embodiments, each LED or illumination unit, of the flat surface or of the central pole, may only be able to toggle between (i) illuminating in a particular color, and (ii) not illuminating at all; for example, a first LED is capable of being toggled between illuminating in red color and not illuminating, whereas a second LED is capable of being toggled between illuminating in green color and not illuminating, or the like. In other embodiments, at least some of the LEDs, of the central pole and/or of the top surface of the gaming device, may be multiple-color or multi-color LEDs or color-changing LEDs that are capable of (i) not illuminating at all, or (ii) illuminating in a first color, or (iii) illuminating in a second color. In some embodiments, each illumination unit may be a tri-color illumination unit or an RGB illumination unit or a tri-color LED or OLED or an RGB LED or an RGB OLED, or may comprise three distinct LEDs or OLEDs; for example, comprising three LEDs or OLEDs that each one of them may be instructed to illuminate red or green or blue (RGB) at an intensity value in the range of 0 to 255; thereby enabling each triple-LED or triple OLED illumination unit to be selectively instructed to illuminate at 256×256×256=16,777,216 different colors, or approximately 16 million colors.

The gaming device may be programmed or configured, and its functionality may be modified or replaced or augmented or updated or upgraded, by connecting it to a computer (or other electronic device, such as smartphone or tablet) and programming or configuring the functions of the device's central system; such as, by updating a software module that indicates to the device which commands to perform and/or in which order and/or at which timing scheme and/or in accordance to which gaming rules, and/or by modifying the content of a data repository or memory unit or storage unit of the gaming device which stores such commands or rules that are then applied or executed by the gaming device's processor and other units. From this point onward, there is no need to connect the gaming device to a computer or to any other electronic device or gaming controller, and it may function as a stand-alone or independent gaming device in accordance with the functions programmed on it, as long as it has power (e.g., from an internal power source, or from an external power source or battery or power cell, or from an electric outlet or electricity generator or other power source).

The programming may take into account input received or captured or acquired from or by the touch sensors. As well as output to the various LEDs or illumination units of the flat surface and/or the central pole. The programming, whether related to games or to other functions of the device, may be tailored specifically to the gaming device itself; and specific programming may allow for flexibility, both in the device's design and in adaptation to its intended use. For example, a first implementation of the gaming device of the present invention may have a total of L1 illumination units and T1 touch-sensors; whereas a second, different, implementation of the gaming device of the present invention may have a total of L2 illumination units and T2 touch-sensors. In some embodiments, the programming of the gaming device may utilize particular values (e.g., “if event X happens, then illuminate LED number 34”); in other embodiments, the programming may utilize ratios or percentage values (e.g., “if event Y happens, then illuminate all the green LEDs”, or “if the remaining time to play is zero, then illuminate 50 percent of the red LEDs in a flashing alternating pattern for three seconds”). Other suitable programming configurations may be used.

In some embodiments, there is no connection or no constant connection or no fixed or pre-defined relation between (i) the touch surface (e.g., a particular touch-based sensor) and (ii) the light that is produced or illuminated near it or around it, or in horizontal proximity to it, or in horizontal displacement relative to it, or under it, or in vertical proximity to it, or in vertical displacement relative to it. The connection or relation may be defined or configured or re-configured per game or per game mode. For example, in a first game or game mode, touching the touch-sensor number 3, may cause LEDs number 4 and 5 to illuminate in green color; whereas, in a second game or game mode, touching the same touch-sensor number 3, may cause LED numbers 6 and 7 and 9 to illuminate in red color; whereas, in a third game or game mode, touching the touch-sensor number 3, does not cause any LEDs to illuminate (or to change their illumination color) unless one or more other conditions hold true (e.g., unless touch-sensor number 5 is also touched at the same time; or, unless the actuation of touch-sensor number 3 has occurred within 0.7 seconds of the illumination of LED number 8; or the like). In another example, a particular touch-sensitive surface or touch-sensor is to be touched (or tapped) by a particular user, only if the illumination units that surround it or point to it or are located in proximity to it or under it are illuminating at a particular color; for example, if the LEDs that surround touch-sensor number 6 are currently illuminating in red color, then that touch-sensor number 6 should not be tapped or touched; whereas, if those LEDs that surround touch-sensor number 6 are later illuminated in green color, then that touch-sensor number 6 should be rapidly tapped or touched. Other suitable rules may be defined, applied and enforced by the gaming device, to reflect these or other relations between (i) illumination of LEDs prior to tapping, and (ii) whether or not a particular touch-sensor should (or should not) be touched or tapped, and (iii) a resulting change in the illumination of those LEDs and/or of other LEDs in the gaming device in response to a “correct” tap or touch and/or in response to an “incorrect” tap or touch.

In some embodiments, optionally, the touch-sensitive surfaces of the gaming device, and/or the touch-based sensors of the gaming device, in cooperation with the processor which executes a particular game logic, may differentiate among two or three or more types of engagement; for example: (a) a single tap of a touch-sensitive surface, which lasts a short time (e.g., one-tenth or one-fifth of a second), which may cause the gaming device to perform a first type of action at or near the touched surface; (b) an elongated tap or continuous tap or maintained tap of a touch-sensitive surface, which last at least T milliseconds (e.g., at least 500 milliseconds, or at least 1 second, or at least 1.5 seconds, or at least 2 seconds), which may cause the gaming device to perform a second type of action at or near the touched surface; (c) a double-tap of a touch-sensitive surface, such as, by two discrete taps that occur within a pre-defined time-period (e.g., within one-quarter of a second), wherein the two taps are distinct from each other and have a short no-touch period between them; (d) optionally, a touch or tap with two fingers, or with three fingers, or with an entire palm or hand, on one single touch-based sensor, which may optionally be implemented as a multi-touch sensor capable of differentiating between a touch performed via a single finger, or two fingers, or three fingers, or a palm or hand; (e) optionally, other types of touch-sensitive or touch-based inputs, for example, a triple tap, a series of discrete or distinct taps, or the like. Each such different type of engagement or input, may be detected and differentiated by the system, and may be matched with triggering a different type of illumination effect and/or audio effect and/or other result (e.g., increase or decrease in a score of a player); for example, a first type of input may cause a prolonged illumination of one or more illumination units, a second type of input may cause a short illumination of one or more illumination units, a third type of input may cause a first animated pattern or display of lights, or the like. In a demonstrative example, a rapid double-tap may cause a “shooting bullet” illumination effect, in which an illumination pattern appears to emulate a travel route of a light bullet that travels from one end of the table to the opposite end, and optionally causes “damage” to the opponent's base by causing one or more illumination units there to deactivate; whereas, a prolonged tap may cause a “shield” illumination effect, in which illumination units that surround the touched sensor remain illuminated for a pre-defined time period (e.g., two seconds), and operate as a “light shield” that stops such “light bullet” that approaches from the other side of the table. Other suitable effects or results may be configured, in response to various types of user engagement or user input.

The touch surfaces or touch-based elements or touch-based tiles of the top flat surface are used as the data inputs or as the input units of the gaming device, and their role is to pass on the touch status or the touch-event to the main gaming controller or processor or processing unit. In some embodiments, the response to each touch-event is not necessarily uniform or fixed; but rather, it may vary, depending on the game played and its rules, as are the lights and sounds that will be produced in response to such touch-events as they operate as the visual and audible output of the gaming device. In some embodiments, a touch-event may require any time-length of touch (e.g., as long as a touch is indeed sensed by the touch-based sensors); whereas in other embodiments, optionally, a touch-event may require touching the touch-based sensor for at least a particular period of time (e.g., at least 0.2 seconds) in order to be counted as a valid touch; other time-lengths may be implemented in accordance with various gaming rules which may be programmed into the gaming device. In some embodiments, the gaming device need not apply or need not enforce a particular time-limit or condition with regard to the time-length of the touch, or with regard to the result of a prolonged or continuous touch (in contrast to a short touch). In some embodiments, the gaming device may be configured such that a rapid or short touch of the touch-sensor may result in a first action (e.g., a first illumination result and/or a first audible result), whereas a prolonged or continuous touch of a touch-sensor may cause a second, different, action (e.g., a second illumination result and/or a second audible result). For example, in some embodiments, a rapid or short touch of a particular touch-sensor, causes a particular set of illumination units to illuminate at a particular color for a relatively short period of time (e.g., 0.5 or 1.0 seconds), accompanied by a short “beep” sound of the same time-length; whereas, a prolonged touch of that particular touch-sensor causes a different result, for example, an animation or a “running light” display across multiple illumination units, and/or a running light that continues to move as long a the prolonged touch is maintained, and/or a musical melody that plays as long as the prolonged touch is maintained. In some embodiments, a prolonged touch of a touch-sensor may cause a particular color of illumination to be animated or moved across multiple LEDs, for example, starting with those that are nearest to the touched sensor, then continuing to the elongated lines of LEDs towards the center of the playing surface, and then even continuing vertically upwardly along the illumination units of the central pole. Other suitable schemes may be configured, with regard to illumination and/or audio output, in response to a prolonged (or maintained, or continuous) touch, in contrast with and/or differentially from a short or rapid or non-continuous touch.

The gaming device of the present invention may be configured or programmed to operate in accordance with various gaming modes or game modes or gaming rules or gaming schemes or operational modes; and presented herein are only some non-limiting examples of such gaming modes or operational modes that may be implemented via the gaming device.

In a first gaming mode, a single player interacts with the gaming device, in accordance with a pre-defined set of gaming rules, a goal to achieve, win conditions, loss conditions, score conditions, time-based conditions, or the like.

In a second gaming mode, a plurality of players interact with the gaming device, each player operating by himself and not in cooperation with others, or each player competing against all other players; in accordance with a pre-defined set of gaming rules, a goal to achieve, win conditions, loss conditions, score conditions, time-based conditions, or the like.

In a third gaming mode, two or more players interact with the gaming device, wherein at least two or more players belong to a first team, and at least one more player belong to a second team that competes against the first team (and optionally, additional team(s) may participate in the same game); in accordance with a pre-defined set of gaming rules, a goal to achieve, win conditions, loss conditions, score conditions, time-based conditions, or the like.

In a fourth gaming mode, two or more players interact with the gaming device in accordance with gaming rules that require them to play in cooperation with each other, rather than against each other, in order to achieve a goal or objective. For example, three players may play together; and each player may be required to tap or touch particular touch-sensors upon illumination of a particular color that is allocated to this player; and the three players may play such that their score is cumulative, and all of them need to continuously play correctly in order for the game to continue, and a mistake by one of the three players causes all three to lose or to forfeit the game. Other rules may be defined and enforced in order to implement a game in which a group of players are required to play in cooperation with each other, rather than playing against each other and/or against another group or team.

In another gaming mode or operational mode, the device functions as a musical instrument; the touch-sensors operate and function similarly to the keyboard of a musical instrument. In response to taps or touch-events on the sensors, the device plays different sounds or tones or sound effects, for example, piano sound, organ, violin, percussion instruments, drums, or the like, as well as sound effects or pre-defined audible outputs (e.g., a pre-recorded sound of a dog bark, or of a rolling thunder). Sounds may be programmed as character sequences across scales, or as pre-recorded audio segments (e.g., in WAV or MP3 format or other audio formats), allowing to play entire melodies on the device. Music can be played by a single user or by or multiple players who operate simultaneously. As the touch-sensors can identify more than one tap at a time, the device can play more than one sound at a time, thus expanding the playing options and enabling to play even complicated melodies.

In another gaming mode or operational mode, the device functions as an independent or stand-alone artistic audio/visual device, for playing sounds and displaying visual lights, with or without movement. This operational mode requires no user intervention with the device during the audio-visual presentation, as the device may play music stored on the memory card accompanied by illuminating lights, in accordance with a particular pattern. The light can be still or fixed, or may change, giving a sense of motion, which may be related or unrelated to the rhythm of the music played, depending on the choices made by the player or by the user who prepared the audio-visual presentation. In some embodiments, this operational mode also allows for the device to be silent, while the LEDs (or other illumination units) react to outside sounds and light up accordingly in response to them and optionally based on pre-defined rules. Additionally or alternatively, this operational mode further allows for LEDs (or other illumination units) to light up with no sound at all, and/or not necessarily in reaction to any sounds; for example, based on a pre-defined illumination pattern. Additionally or alternatively, this operational mode allows to create an animated light display or presentation that can be used, for example, to display a company's brand colors, logos, texts, or other content on the central pole and/or via the top flat surface of the device.

In another operational mode, the device may operate for physical activity per instructions, and may be structured and configured to support various physical body movements, such as, as part of physiotherapeutic therapy which may be guided by the lights and sounds generated by the device.

Other suitable modes of operation may be configured or programmed into the device, or may be pre-manufactured into the device during its manufacturing process, or may be subsequently downloaded or installed or incorporated into the device in order to modify or enhance or augment its functionalities.

In some embodiments, the selection and change of modes of operation of the device may be performed by the players (users), using one or more suitable methods. For example, the game mode may be selected or changed via a manual switch or other mechanical element (e.g., button, lever, slider, pin, or the like) that allows the user to select the desired operational mode; the switch may be mechanical or physical, or may be controlled through touch sensors (e.g., that are not part of the touch sensors that are the input units located at the top surface of the device). Additionally or alternatively, the operational mode of the device may be selected or modified via a remote command, transferred to the device over a wired link or a wireless link from another apparatus such as a computer or smartphone or tablet. Additionally or alternatively, the device may comprise a microphone able to capture voice utterances of users, and a speech-to-text converter, and a processor to enable voice-based commands for controlling the gaming device and for changing or selecting its operational mode.

In some embodiments, the main form of activity of the device is its function as a game table. The games programmed into the gaming device of the present invention are developed particularly for this gaming device, and are designed or configured to fit or to accommodate or to utilize its unique physical structure and electronic functionalities, thereby enabling a diversified and wide range portfolio of games which can be programmed into this unique gaming device.

Some of the games may be based on quick thinking and fast reaction time. In some cases, they are multi-player competitive games, in which the competition may be between individuals or between teams. In these games, typically all the players play simultaneously, and the best results will be achieved by those reacting with greater speed and/or accuracy. The game will usually end once a player (or team) reaches the end goal (e.g., performing X particular moves correctly), and/or once a pre-defined time limit (e.g., T minutes) is reached. When the goal is reached by a player (or team), the gaming device may announce (in one or more ways, such as audibly, via illumination of lights, or the like) the winner, and the game ends. Once a game ends, the players have the option to start a new game, or they may switch to a different game programmed into the device, or they may switch to a different operational mode of the device altogether. In some embodiments, each game may be associated with a game identifier or a game name; for example, “four in a row” or “color catcher” or “who is the fastest” or “think and touch” or other suitable names.

Other games are not based on speed, but rather, may be based on thought, thinking, logic, concentration, focusing, patience, strategy, and/or memory. These games, when played by multiple players, are usually played by taking turns, such that each player makes his move in turn. Some of the games allow for a time limit for each move, and/or for the entirety of the game; and the gaming device may operate to monitor such time limit(s) and to enforce them.

In some embodiments, the gaming device does not identify players, but rather, it identifies which touch-sensors were touched or pressed or tapped. Therefore, in some games that are operated via the gaming device, each player is represented by a particular different color, usually determined at game start. For example, to start a competitive game, each player touches or taps or presses a different touch-sensor. As result, LEDs around that touched sensor will light in a particular color, which will be the color representing this particular player (e.g., Adam=red, Bob=green, Carl=yellow, and so forth). In some embodiments, the illumination units or LEDs may be arranged in a triangle shape around each touch-sensor, although other suitable arrangements and/or shapes may be used. When announcing victory, the winning color of the winner will light up, and the player represented by this particular color is the winner of the game.

In some embodiments, the gaming device may be capable of wireless communication, via a Wi-Fi transceiver, a Bluetooth transceiver, a cellular transceiver, or other suitable wireless transceiver which may enable communication between the gaming device's Control Unit and an external apparatus (e.g., a computer, a smartphone, a tablet) and/or the Internet, and/or which may enable to remotely control or configure the gaming device of the present invention. Such communication may enable to remotely transfer or update or upgrade or add or modify the operational modes of the device, or to load new modes via remote programming. Connecting the gaming device to the Internet or to a particular pre-defined remote server, may enable a wide variety of options, such as Artificial Intelligence (AI) management, or sending to a remote server one or more indications or log reports regarding the state or status of the gaming device, problems, errors, malfunctions, analytics about its usage (e.g., “the device was played for a total of 15 hours during the past 24 hours”; or “Game Mode number 1 was played 90 percent of the time during the past week”), or the like.

In some embodiments, voice communication capabilities may be used to enable users to voice instructions and to enable the gaming device to receive voice-based commands or information from users. These capabilities may be implemented via a local or remote Artificial Intelligence (AI) unit, and/or by using a speech-to-text converter or other local or remote Speech Recognition (SR) or Automatic SR (ASR) units; and optionally by utilizing a particular set of vocabulary words or “dictionary” that is relevant to the gaming table and which may be programmed into the gaming device itself and/or into the local or remote unit that performs the analysis and recognition of voice-based commands or voice utterances.

In some embodiments, optionally, one or more motion detectors or motion sensors may be included in the gaming device, in order to sense or detect the presence and/or motion of people around the gaming device, and/or in order to take into account such presence and/or motion as part of a particular gaming mode and/or in as part of other functionalities of the gaming device.

In a demonstrative implementation that utilizes the above-mentioned features, the gaming device is located in a public space and is currently in a silent mode, running and displaying lights in colors that match the place or business in which it is located. People pass by the gaming device which is an operating as an illuminating table, and this is sensed and recognized by the motion detectors. The gaming device responds with a movement of lights, unique sounds, and a vocal call to potential players. The gaming device now has the attention of nearby persons and asks them in a human voice whether they would like to play. The people around the gaming device answer positively, and the gaming device performs ASR to recognize and understand the positive answer and to operate accordingly. The gaming device asks them how many players they are, and receives their vocal answer (e.g., “three”) and recognizes it. The gaming device then tells them that it has great games for three, and it asks whether they prefer to play a fast paced, competitive game, or a turn-based strategy game. Based on their vocal answer, the gaming device automatically switches to a gaming mode that matches their preference and also matches the number of players. The rules of the game may be briefly explained, and the game itself starts via the gaming device. In the course of the game, the gaming device may occasionally comment and make remarks, such as a rebuke to the player who is currently in the last place, or exclamations of admiration for the current leading player. The gaming device indicates the particular colors that represent the various players. At the end of the game, the gaming device asks the players if they would like to play another round, or to switch games, or to switch to another operational mode of the device. At closing time, the owner of the place in which the gaming device is located (or, the owner of the gaming device itself) turns off or deactivates the gaming device remotely from his mobile device or smartphone or tablet or via a remote wireless connection. The gaming device may playback a polite “goodbye” message to those present, and turns itself off or deactivates some or all of its features or enters into a sleep-mode or reduced-power mode.

In a demonstrative embodiment, the gaming device may be used for enabling a game that is based on fast reaction or quick reflexes of players. For example, at game start, each one of the players (e.g., of 2 or 3 or 4 or 5 or 6 players, in this example) touches or taps a different touch-sensor that is surrounded by a triangle of white LEDs. Following the touch, the LED triangle will light up with the particular color that is allocated to each player. A few seconds after a color was selected for at least two players, the game begins. Each time that a player's selected color lights up anywhere upon the device's surface, the player who is associated with that particular color must tap the surrounded touch-sensor as quickly as he can. Once tapped, this particular color will randomly move elsewhere on the surface, and once again the player is required to find it on the surface and to tap its touch-sensor as quickly as possible; and so forth. In some implementations, if the particular color moves to a triangle that is already lit by a different color, then the latter will be moved elsewhere, and therefore fast reaction and quick reflexes may be important in this type of game; since if a player lingers, his color might move elsewhere, or he might accidently tap the sensor immediately after the color has already changed and thus may give his opponent a point. Each correct tap on a touch-sensor, gives a point to the player that is represented by that particular color, and that particular color lights up and advances up the central pole of LEDs that is located at or near the center of the gaming device. The first player whose color reaches the top of the central LED pole wins the game, and the winning color takes over the entire surface. Each game session lasts for a pre-defined time-period (e.g., 90 seconds), or lasts until a player reaches a pre-defined goal of correct taps; the goal may be set based on the number of players and their agility. This game entails rapid hand movements and color exchanges in different places, and high levels of excitement, and is accompanied by sound that enhances the gaming experience.

In some embodiments, the gaming device may be configured or programmed or implemented to particularly enable color-blind persons to play or to participate, and/or to particular enable disabled persons to play or to participate. For example, in a demonstrative implementation that may be suitable for multiple players who are color-blind, instead of allocating different illumination colors to different players (e.g., Adam with red, Bob with green, Cathy with blue), the same color yet at different illumination intensity levels may be allocated to different players (e.g., Adam with high-intensity yellow illumination; Bob with medium-intensity yellow illumination; Cathy with low-intensity yellow illumination); or, other illumination effects may be used in such situations (e.g., Adam needs to touch a sensor only if the illumination units around it flicker one time; Bob needs to touch a sensor only if the illumination units around it flicker two times).

This example reflects an electronic game that is physical, high paced and exciting, and physically social (requires concurrent co-presence of the players in proximity to each other), which is an experience that cannot be attained through electronic games that are played via screens and game controllers.

In a demonstrative experiment, a 70-year old woman and a 6-year old girl enjoyed playing this game against each other via the gaming device. The young girl had an agility advantage, but she sometimes found reaching all the touch-sensors with her hands challenging, and had to do a lot of walking or running around the table. The older woman had longer arms yet slower reaction time and slower reflects; she did not have to run around the table to reach the touch sensors, but she sometimes found rapidly identifying her color challenging in itself. This created a nicely balanced match, and both players, in spite of their significant age difference and different skills, found the game challenging and exciting. This attribute is generally lacking in conventional video games and computer games.

As mentioned above, the gaming device may also host games which are not based on speed or fast reflexes, but rather on thought, thinking, logic, concentration, focusing, patience, strategy, and/or memory, where the gaming rules and logic are preprogrammed into the gaming device, and may be played by two or more players or by a single player.

In another demonstrative embodiment, the gaming device may be used for enabling a game that is based on taking turn, or a turn-based game in which each player plays in his turn. It can be played by 2 to 4 players (or other number of players) competing against each other. In the following example there are three players, named Adam, Bob, and Cathy, each represented by a particular different color. The winner of the game is the first player to complete one of the following: (a) a sequence of four triangles of his/her color; or (b) a sequence of four consecutive stripes of his/her color; or (c) a sequence of one long strip of his/her color across the table from one side to the other, with triangles of the same color at both ends.

At the start of the game, a player enrollment stage is performed. pink lights flicker on all of the triangles around the touch-sensors. Simultaneously, a white light ring slowly descends the external surface of the central pole from top to bottom, and a recorded voice instructs those players who wish to join, to touch one of the triangle sensors. The game will start once the ring arrives at the bottom of the central pole, and two or more players have joined the game. If the ring has reached the bottom of the central pole before two players have joined the game, it will start falling again from the top of the central pole, and will continue to do so repeatedly until two or more players joined, or until the game mode is changed. The length of the ring drop is about 10 seconds, allowing a pre-defined reasonable time for all interested players to join the game, which starts automatically seconds after a sufficient number of players have joined. At this point, the gaming device knows how many people are playing the current round (based on the number of different touch-sensors that were tapped during the player enrollment stage), and will adapt its operation to this particular number of players.

While all the triangles flicker with pink lights and the ring slowly go down along the central pole, Adam touches one of the sensors and the triangle around the touched sensor becomes a solid pink color. The remaining triangles continue to flicker, but their color turns green. Bob touches another particular sensor and the color around that sensor is fixed on green. The rest of the sensors, except Adam's pink and Bob's green, continue to flicker but this time in purple. Cathy now touches another sensor before the white ring reaches the bottom of the central pole in order to join the game. The triangles around her touched sensor become permanent purple, and the rest of the sensors continue to flicker, this time in orange. The ring completes its descent along the central pole and reaches the bottom before anyone else touches another sensor, and at this point the game begins with the gaming device registering that a total of three different players are enrolled, with colors of pink, green, and purple. As mentioned, the enrollment stage may last approximately 10 seconds, or other suitable time-period.

Once the ring reaches the bottom of the central pole and a sufficient number of players have joined, all the LEDs are turned off, including those that were lighted around the triangle sensors, and the game begins. Adam is the first to play, and the central pole lights up in his color, which is pink. Since this is a turn-based game, there is no importance to the speed in which Adam makes his move; and until Adam completes his move, his turn will not pass on to the next player. Adam touches a triangle sensor of his choice, and that triangle lights up in pink. It is now Bob's turn, and the pole lights up in Bob's color, which is green. Bob touches a triangle sensor of his choice, and that triangle lights up in green. It is now Cathy's turn (purple). Cathy chooses to touch a triangle that is not empty, but is already lit with Bob's color (green). When she does this, the triangle changes its color from green to her color which is purple, while Bob's green LEDs moves from the triangle to the strip above it.

The game continues as each one of the players, in his turn, touches a triangle (he may choose any of the 12 touch-sensors, regardless of whether a touch-sensor is already lit up or not), and the triangle lights up in his/her color; and the color of touched triangle, if there was such color prior to a fresh touch, moves to the stripe above the triangle and the color of this stripe moves to the stripe after it or opposite it (e.g., located across the surface on the opposite side of the table). If this stripe also was already colored, this color moves to the triangle on the opposite side, and colors it.

As the game progresses all (or some of) the triangles and stripes can be lit up in the colors of the players in a mixture, and the players must find a way to complete the four consecutive triangles of their color, or four strips, or a long stripe and two triangles at the ends to win the game. In addition, players can in their turn interrupt or block another player who is trying to build a sequence or pattern. In some embodiments, for example, player Adam may notice that he has three stripes illuminated in a row, and that his allocated color is now also illuminating at the touch-sensor located at the end of those three stripes-in-a-row, and his touch or tap on that particular sensor may cause him to obtain a fourth stripe in that row and thus he wins the game. In another example, player Bob notices that player Cathy has three illuminated triangles or stripes of her particular color; and player Bob thus intentionally touches one or more sensors in order to cause one of those three illuminated items to change color from Cathy's color to Bob's color, in order to “block” Cathy from winning

After a few turns, on Cathy's turn, she notices that there are three consecutive triangles in her color, and she touches a fourth triangle next to those three. She thus has four consecutive triangles lit up in her color, which makes her the winner, and the game ends. The winning sequence will flash several times on the table surface. A victory sound is generated, and the game will announce the winning color (purple in this case). Optionally, after a few seconds pass, the game may reset to its starting point, and other players will be able to play, or a player who has not managed to join previously will be able to join in this new round.

It is noted that the mechanism of adding players to a game while a ring of light descends the central pole, ma enable efficient enrollment of players and an easy and convenient way to add a variable number of players to each round. This mechanism may be used in other games of the present invention, which allow for two or more players. The enrollment stage is typically performed at the beginning of the game, in a similar way to that described above, thus defining (and registering with the device) the number of participants in each round of the game.

In accordance with the present invention, the flexibility brought forth by modular programming, allows for the creation and/or adding and/or modification of hybrid games that may combine both types of challenges, such as a shooting game that calls for attack and defense moves, which may require both agility and fast thinking tactics and/or making choices that provide strategic benefits. Aside from the specific one or more selected games that may be encoded or pre-programmed into the gaming device, the level of difficulty or complexity of the games can also be tailored or modified to a specific target audience. For example, a gaming device that is planned to be placed in a retirement home or an assisted living facility or a senior citizens housing facility, may be configured to accommodate an older age group; the time allotted for response may be longer, and/or the lights and sounds may also be programmed to better suit this age group (e.g., louder sounds, longer illumination periods). Alternatively, a gaming device for a kindergarten or elementary school may include games that have more simplistic rules, yet may require more movement, and sounds and lights may be configured to fit a young age group. In some embodiments, the speed or rhythm or tempo or time-length of a game, may be dictated by the respective speed or rhythm or tempo of the particular players that engage with the gaming device, without the need to re-configure the gaming device or to change any programmable parameters; such that the same game may be comfortably utilized and play by a group of teenagers, or by a group of senior citizens. In a demonstrative example, the game progresses only upon a touch of a touch-sensor; and therefore, the gaming device would automatically and autonomously progress the game based on the real-life tempo of the actual players; for example, the group of teenagers may tap or touch the sensors every one second on average, whereas the group of senior citizens (playing separately on the same gaming device on a different day) may tap or touch the sensors every four seconds on average, and in each case the gaming device accommodates the group of players and progresses according to their rhythm.

The unique combination of a game that is physically large, designed or structured for multiple players, both physical and electronic, with the fact that it is programmable and adaptable to different needs and/or users, differentiates the gaming device of the present invention from conventional electronic games, such as the simplistic memory game known as “Simon” which is a hand-held small-size memory game with limited game options), or the similarly simplistic memory game known as “Merlin” which was a hand-held small-size memory game with a constant number of single-player games), or a pinball machine (e.g., a single-player game having a slanted table with a physical ball moving through physical obstacles).

For demonstrative purposes, the following are only some of many particular differences between the gaming device of the present invention and a conventional hand-held single-player memory sequencing game such as “Simon” which is mainly defined and tailored to be played by a single player. (1) Simon is a limited memory sequencing game with 4 buttons and 4 lights, as opposed to the possibility of expanding input and output in the gaming device of the present invention, which may utilize (for example) 12 input sensors and an almost infinite spectrum of colors. (2) The gaming device of the present invention can play an unlimited variety of sounds and melodies, as opposed to Simon, in which a very limited number of monotonic sounds are played. (3) In the gaming device of the present invention there is no constant or fixed connection and/or no necessary relation between the touch surface that is touched (or tapped, or clicked) and the light or illumination that is produced around it or near it or in response to it; rather, the connection or relation is defined per game, and touching a particular touch-sensor may produce a variety of illumination responses and/or audible responses which are presented by variety of colors and/sounds and may be at different locations of the top surface and/or the central pole, depending on the current operational mode of the device and the current situation when the touch-sensor was touched; in direct contrast to Simon, where each particular button produces always the same particular audible tone and causes the same particular illumination at the same particular color and in the same exact location, and wherein the illuminated location is the same location of the clicked button. (4) Simon is a small-size hand-held limited game that is mainly designed for a single player and provides a particular monotonous gaming experience; whereas the gaming device of the present invention is a large (e.g., table size) product configured to be used by several players simultaneously, bringing forth social interaction and requiring physical movement of the player around the large gaming device. (5) The gaming device of the present invention is a programmable platform which can host an unlimited number of different games, as well as other functionalities as described above, that can be programmed in a flexible and endless way and by using a common code language or programming language, which may allow for dynamic modification or augmentation or updating of game(s) installed on the gaming device; and this makes the gaming device of the present invention suitable for use by any targeted audience and in diverse situations and settings and environments; the games are not only sequence memory-based as in Simon, but may also require speed, tactics, strategy, agility, fast reflexes, or the like. The games and all other various options in the present invention can be pre-programmed, or may programmed later by the end-use or by a third-party developer or administrator. It is noted that the Simon game utilizes push-button switches, in which each particular push-button is strictly and fixedly associated with a single particular fixed color of illumination and with a single particular fixed tone of audio beep; and that it is, basically, a Sequencing Memory Game, in contrast with the abilities and functionalities of the system of the present invention.

Accordingly, the only connection between a conventional game of “Simon” and the gaming device of the present invention is that both are electronic games utilizing lights and sounds, but beyond that there is no other connection between the two. No existing game, whether physical electronic game, video or computer game, or table game, offers the unique solutions and combination of features that the gaming device of the present invention provides: A physical electronic game, allowing for single or multiplayer participation, that is programmable and highly adaptable, and in which there is a non-fixed relation (in location, or in position, or in logic) between a touch on a touch-sensor and an illumination of one or more lights and/or generation of one or more sounds.

The gaming device of the present invention may be implemented in various ways; for example: (1) a Basic version, configured to be used in public places, and pre-loaded with a few (e.g., three) operational modes; (2) an Extended version, having additional (e.g., six) operational modes; (3) a Connected version, which further includes wireless communication connectivity (e.g., over Wi-Fi link, Bluetooth link, cellular link, or the like) which enable the gaming device to be controlled and/or updated and/or augmented from or via a remote apparatus (e.g., a computer, a smartphone, a tablet, a remote server) and/or via a dedicated application; (4) a Smart version, which further includes AI capabilities and/or voice-command capabilities, via a local or remote voice command module, which allow the gaming device to interact verbally with people around it; (5) an Outside/Outdoors version, configured or structured to withstand outdoor weather, and/or to be waterproof or dirt-proof; (6) an Open version, which may be modified or programmed by the owner via a dedicated API or other interface; (7) a Luxury version, which may be formed of upscale materials such as heavy wood and/or expensive metal and/or expensive glass, implemented as a luxury piece of furniture.

The gaming device may be implemented in the form of a surface only, or as a surface with a central pole. It may include legs or support units, or may be flat without such legs in order to be placed on a surface (e.g., a table, countertop, floor). In some embodiments, the gaming device may have legs which may be detachable and/or foldable, with an optional height adjustment feature (e.g., screwing or threading mechanism, telescopic mechanism, or the like), allowing for comfortable use by children and/or adults, in a standing or sitting position.

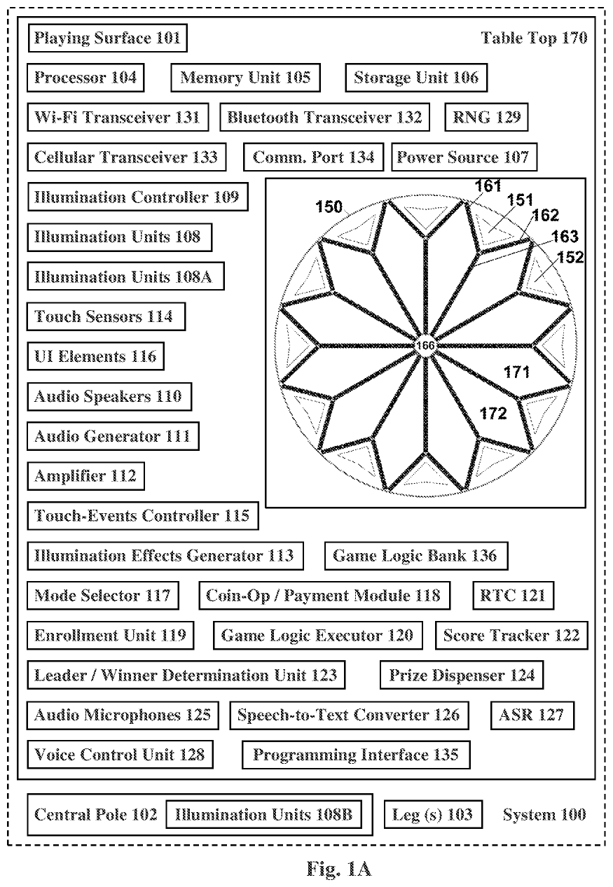

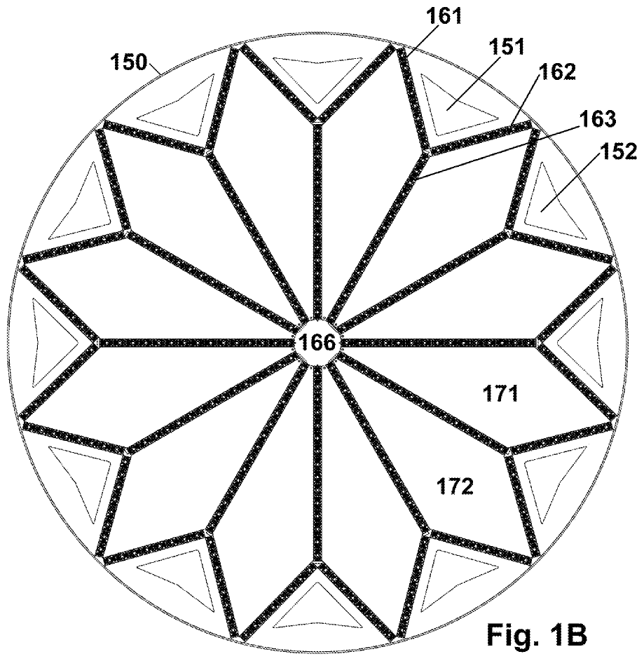

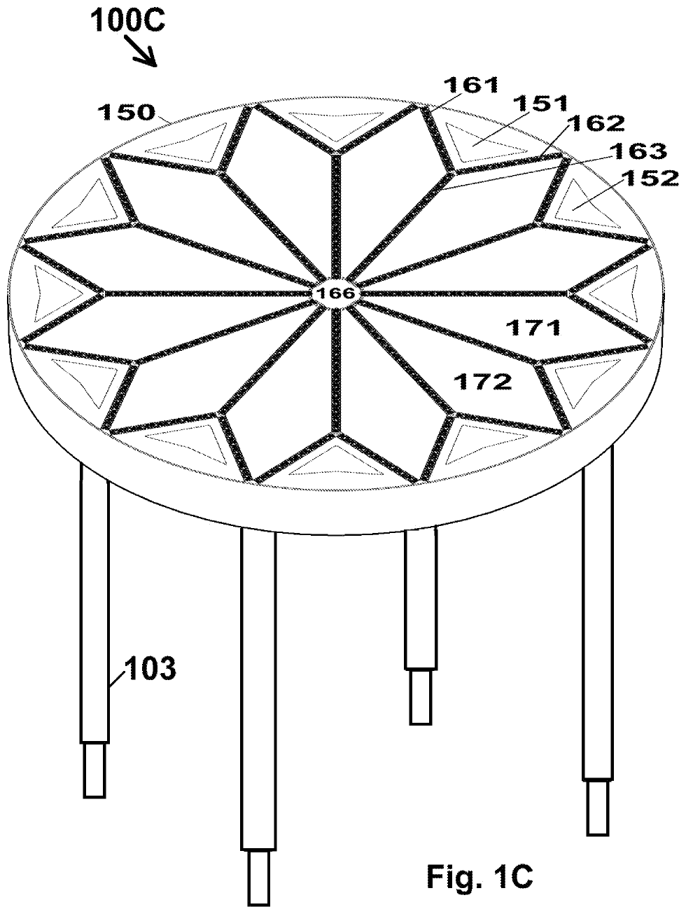

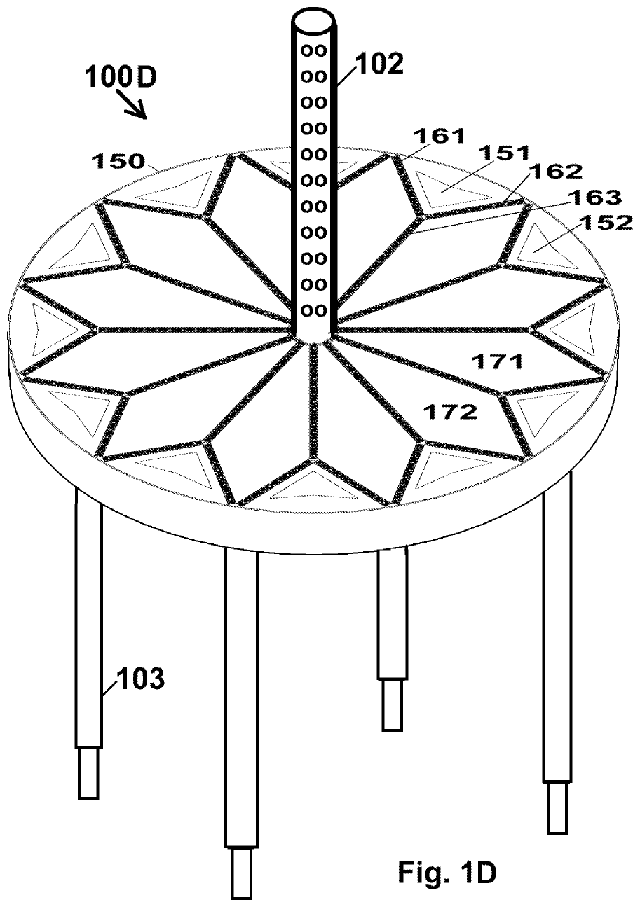

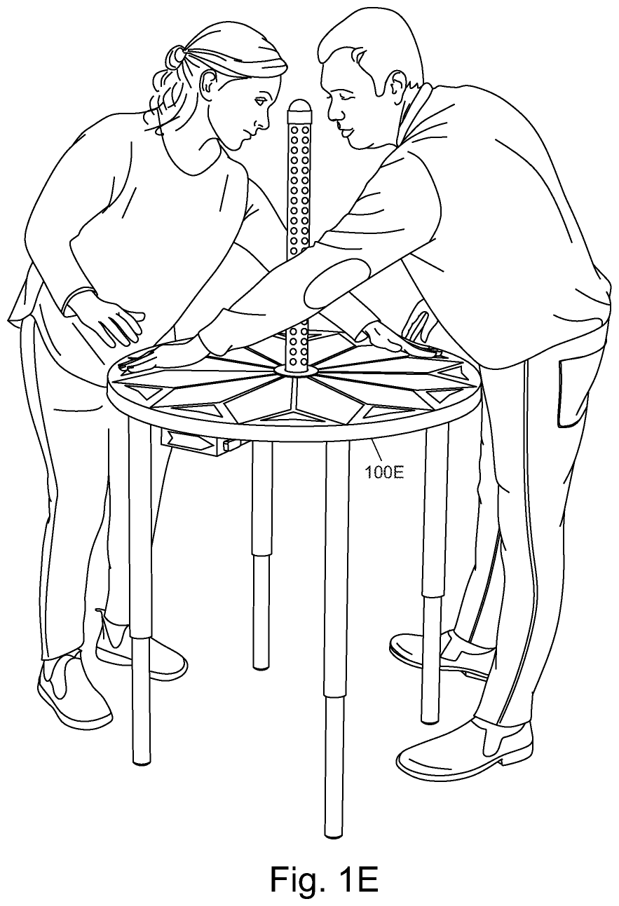

Reference is made to FIG. 1, which is a schematic illustration of a system 100, in accordance with some demonstrative embodiments of the present invention. System 100 may be a demonstrative implementation of the gaming device of the present invention. In some embodiments, optionally, system 100 may be structured to include as a generally-flat table-like playing surface 101 that is generally parallel to the ground or to the floor, able to stand on three or more support legs 103 (or, on a single, central, support leg) which may optionally be foldable or detachable, and having a functional central pole 102 that is generally perpendicular to the playing surface 101. The playing surface 101 may be implemented as, or as part of, a table top 170; which may have depth and physical storage capacity, such that some or all of the other units or modules that are described herein may be housed within or encapsulated within such table top 170, and/or may be mounted or connected underneath it. It is noted that the support leg(s) 103, whether a single central support leg, or three or four or other number of support legs, may be optional or may be detachable or foldable, or may include an expansion or shortening mechanism enabling a user to selectively shorten or extend the length of one or more of the legs in order to ensure that the entire system 100 is stable and/or fixed and/or non-rocking and/or balanced, and/or in order to make the table top 170 and/or the playing surface 101 be approximately at or near the waist level of a user.

System 100 further comprises a processor 104, for example, a controller, an Integrated Circuit, a processing core, an Application-Specific IC (ASIC), a Central Processing Unit (CPU), a Digital Signal Processor (DSP), a controller, a micro-controller unit (MCU), a micro-processor unit (MPU), a system-on-a-chip (SOC), or other unit able to execute program code and/or machine-readable instructions and/or able to control or regular other units and/or able to execute logic representations and/or able to command other units to activate and/or deactivate and/or to modify their operational properties. Processor 104 may execute one or more commands or code or programs which may be stored in a memory unit 105 (e.g., Random Access Memory (RAM), Flash memory, or the like) and/or in a storage unit 106 (e.g., hard disk drive (HDD), solid state drive (SDD), optical and/or magnetic storage medium, or the like). It is noted that in order to not over-crowd the drawing, FIG. 1 shows the numerous units and components of system 100 without their coupling or inter-communications; however, it should be readily understood that any unit or module or component in system 100 should be regarded as being able to communicate with (or receive data or signals from, or send data or signals to) any other component(s) of system 100, even if such components are not connected by a line in the drawing.

A power source 107 may provide electric power and/or voltage and/or current to processor 104 and/or to the other units or modules of system 100. Power source 107 may be or may comprise, for example, an internal power source, an external power source, a connection to an electric outlet or socket, a battery or power cell, a rechargeable battery or power cell, or the like. In some embodiments, power source 107 may be solar based, or may comprise or may be connected to a photovoltaic (PV) solar panel able to generate electricity from sunlight. In some embodiments, power source 107 may utilize kinetic energy in order to generate electricity; for example, requiring a first human user to turn mechanical pedals which may then generate electricity that powers the gaming system that is played by two other human users. Other suitable sources of energy (or a combination thereof) may be used.

For demonstrative purposes, there is shown a demonstrative implementation of a playing surface 150, as a particular implementation of playing surface 101; shown as part of system 100 in FIG. 1A, and also shown in an enlarged version in FIG. 1B. It is noted that playing surface 150 is only a non-limiting demonstrative example of a playing surface in accordance with the present invention, and other suitable playing surfaces may similarly be used as part of the present invention and as particular implementations of playing surface 101 and/or of table top 170.

System 100 comprises a plurality of illumination units 108, such as LED units, Organic LED units, color-changing LED units, color-changing OLED units, incandescent light bulbs or lamps (e.g., using heated filament inside a glass envelope), Halogen lamps, Neon lamps, Fluorescent lamps, or the like. In some embodiments, each illumination unit 108 may be a tri-color illumination unit or a tri-color LED or OLED, or may comprise three distinct LEDs or OLEDs; for example, comprising three LEDs or OLEDs that each one of them may be instructed to illuminate either red or green or blue (RGB) at an intensity value in the range of 0 to 255; thereby enabling each triple-LED or triple OLED illumination unit to be selectively instructed to illuminate at 256×256×256=16,777,216 different colors, or approximately 16 million colors. In some embodiments, since many of these colors would appear very similar to a human eye, the system may utilize a pre-defined list of table or lookup table of RGB illumination values, and may effectively utilize only 12 or 16 or 20 or 32 pre-defined different colors that most humans can easily differentiate; for example, RGB values of (255,0,0) correspond to red; RGB values of (0, 255, 0) correspond to green; RGB values of (0, 0, 255) correspond to blue; RGB values of (255, 255, 0) correspond to yellow; RGB values of (255, 0, 255) correspond to purple; RGB values of (128, 128, 128) correspond to gray; RGB values of (128, 64, 64) correspond to brown; RGB values of (255, 128, 255) correspond to pink; RGB values of (255, 255, 255) correspond to white; or the like. Other suitable pre-defined combinations of RGB values may be used in conjunction with such lookup table or color-definition table.

The illumination units 108 are selectively controlled, activated and/or de-activated by an illumination controller 109, which may further be able to selectively modify one or more operational properties of such illumination unit(s), for example, the intensity or strength of illumination, the color of illumination (e.g., particularly where the illumination units are implemented as color-changing LED units), the timing of illumination, or the selective generating of flickering or illumination bursts or illumination pulses or other illumination effects; as well as the generating of illumination-based animation or emulated animation or simulated animation, for example, by selectively activating and de-activating particular illumination unit(s) to generate a “running light” or other illumination effects. In some embodiments, optionally, an illumination effects generator 113 may be responsible for generating and outputting such illumination effects or animations or “running lights”, based on pre-defined logic and by selectively controlling which illumination units 108 are activated or are not activated as well as the exact timing of such selective activation and de-activation, and/or for generating and outputting an illumination effect having a static pattern of colors or a dynamic pattern of colors.

Some of the illumination units 108, such as playing surface illumination units 108A, are located at, or in, or near, or in proximity to (or immediately under), or within, the playing surface 101; particularly in locations that enable a user to view their illumination through a top area of the playing surface 101, which may be formed of transparent or partially-transparent or semi-transparent plastic or glass or other suitable material(s). Some other of the illumination units 108, such as central pole illumination units 108B, are located at, or in, or within, the central pole 102; particularly in locations that enable a user to view their illumination through the side(s) of the central pole, which may be formed of transparent or partially-transparent or semi-transparent plastic or glass or other suitable material(s). In some embodiments, illumination units 108 may also be located in other regions or areas of system 100; for example, at or near or within side panels of the playing surface 101, or under the playing surface 101.

One or more audio speakers 110 may be comprised in system 100; for example, in or on or under or within the playing surface 101, and/or in or on or under or within the central pole 102, and/or in other regions or areas of the system 100. The audio speakers 110 may output music, musical tones, melodies, sound effects, “beep” sounds, verbal messages, voice utterances, speech segments, and/or other audible items or content, which may be pre-stored as digital content items in the memory unit or storage unit, and may be generated via a sound generator 111 (e.g., optionally comprising a digital-to-analog converter) and/or via an amplifier 112, in accordance with pre-defined logic that controls the sound generation. In some embodiments, the plurality of audio speakers 110 may be selectively and/or differentially controlled by the sound generator 111; for example, such that a first audio speaker (e.g., located near the north area of the playing surface) will output a first sound effect in response to a touch-event in that area of the playing surface, while other audio speakers remain silent, or while one or more other audio speakers produce or output other sound effect(s) in parallel or concurrently; for example, while a second audio speaker (e.g., located near the south area of the playing surface) remains silent, and while a third audio speaker (e.g., located near the east area of the playing surface) produces a different sound effect concurrently with the audio output of the first audio speaker. The sound generator 111 and/or amplifier 112 may thus selectively and separately generate, control and/or amplify audio output via particular audio speakers at particular locations of the system 100, thereby providing an audible output that is tailored to address a particular touch-event or a particular condition or criterion (e.g., success of a player; fail of a player; end of game; or the like), and/or enabling the system to avoid a situation in which all the audio speakers are constantly or continuously beeping or sounding due to multiple touch-events.

Multiple touch-sensors 114 or touch-sensitive surfaces or touch-sensitive elements are further comprised in system 100; for example, in a demonstrative embodiment, twelve touch-sensors are located at or near the outer perimeter of the (e.g., circular) playing surface 101. Each touch-sensor 114 is a unit able to sense that a human user touched or tapped or pressed or otherwise interacted with a top flat surface of the touch-sensor, and is able to send a signal to a touch-event controller 115 indicating the recognition of such touch event. Each touch-sensor 114 may be, for example, a resistive sensor or panel, a capacitive sensor or panel, an optical imaging sensor (e.g., using imagers or infra-red imagers beneath the sensor), a touch-screen, a touch-pad, or the like.

In some embodiments, a touch-sensor 114 sends out a “touch” signal immediately upon initial registration of a touch event; and sends out another, separate, “no touch” signal once the touch event has physically ended. In other embodiments, a touch-sensor 114 sends out a “touch” signal continuously as long as it is being touched by a user, or repeatedly at discrete time intervals as long as it is being touched by a user. In other embodiments, a touch-sensor 114 sends out a “touch” signal upon an initial touch; then, does not send additional signals (touch or no-touch) until a next touch event; and then, sends out a subsequent “touch” signal upon the next touch event. Other suitable signaling methods may be used by the touch-sensors 114. In some embodiments, the touch-event controller 115 may sample or poll the multiple touch-sensors 114, for example, in parallel or concurrently, or serially or in a particular order, or at pre-defined time intervals (e.g., every T millisecond, or every N clock-cycles of the processor), or at pre-defined sampling rate or sampling frequency (e.g., at least M times per second).

In some embodiments, optionally, some of the touch-sensors 114 or all of them may further be able to sense, and to signal or pass to the touch-event controller 115, other properties of a touch event. For example, a touch-sensor may be able to sense the force or average force or maximum force of a touch-event, and to signal or pass such data to the touch-event controller 115. This may enable the system 100 to support gaming modes or operational modes that take into account, optionally, not only the binary capturing of “touch”/“no touch” at a touch-sensor; but rather, to also sense and utilize an input indicating the force level that was applied in a particular touch event, thereby enabling the system to require users to tap a touch-sensor “gently” or “harshly” as part of a particular gaming mode; or thereby enabling the system 100 to operate as a musical instrument that is sensitive and responsive also to the force level that was applied to each touch-sensor. Additionally or alternatively, some or all of the touch-sensors 114 may comprise (or may be associated with) a fingerprint scanner, which may scan and identify a fingerprint as belonging to a particular player (e.g., based on an initial enrollment process in which each player registers his fingerprint), thereby enabling the system to provide particular games (or activities) in which a particular person, and only him, is required to touch a particular touch-sensor, and the system would be able to verify whether or not the touch-sensor was indeed touched by that particular person, based on fingerprint scanning and recognition.

Reference is made now to the particular sub-units of the demonstrative playing surface 150, as depicted in FIG. 1A and as also depicted in enlarged format in FIG. 1B. For example, playing surface may comprise twelve touch-sensitive surfaces, two of which are denoted with numerals 151 and 152; which may be arranged, for example, similar to the twelve numbers of a standard clock, each one of them within a 30 degrees “slice” of an entire circle which spans 360 degrees. Each touch-sensitive surface may be partially surrounded by two rows of LED units or OLED units or other illumination units arranged in a row; for example, there is shown touch-sensitive surface 151, shaped as a triangle or an arrow-head quadrilateral pointing inwardly towards the center 166 of the playing surface 150; such that two edges or two sides of the touch-sensitive surface 151 are adjacent to two rows 161-162 of illumination units which partially surround it. Additionally, an elongated row 163 of illumination units is also arranged in a pattern that points from the center 166 of the playing surface 150 towards the inwardly-pointing corner of the touch-sensitive surface 151. The selective illumination and/or light-based animation of the rows 161-162 and/or of the row 163, may be used by the system to signal to a human user that he is required or requested to touch this particular touch-sensitive surface 151 that is surrounded by these particular rows 161-162 or that is adjacent to this particular elongated row 163. It is noted that other configurations or arrangements may be used; for example, LEDs or illumination units may be arranged under a touch-sensor, or partially under it (vertical displacement) and partially near it (horizontal displacement); or may be stripe shaped, row shaped, line shaped, or arranged as a matrix or array or pattern of illumination units that may surround the touch-sensor or may have the same shape of the touch-sensor. In some embodiments, a set or array or matrix of illumination units need not necessarily be illuminated all-together; but rather, for example, may be illuminated in a selective manner or in accordance with a pre-defined illumination pattern or animation or may display a “running light” animation.

Further shown are twelve deltoid-shaped or kite-shaped or diamond shaped regions, two of which are denoted with numerals 171 and 172, indicating other regions of the playing surface 150 which may be functional or may be non-functional. For example, in some embodiments, regions 171-172 (and the ten other kite-shaped regions which are depicted) may lack touch-sensing capabilities and may not be touch-sensitive, and may also lack illumination capabilities and may not include within or under them any illumination units. In other embodiments, regions 171-172 (and some or all of the ten other kite-shaped regions which are depicted) may have touch-sensing capabilities and may further be utilized by the system as touch-based input units; and/or may also have, embedded within them or underneath them, one or more illumination units which may turn those regions 171-172 (and the other regions) to operate as additional visual output units.

In some embodiments, the center 166 of the playing surface 150 may optionally be hollow, to enable the central pole 102 to passes through it and/or to be fixedly connected steadily through it, or in order to steadily hold in place the central pole 102 which passes through it. In other embodiments, the center 166 of the playing surface may be solid and non-hollow, and the optional central pole 102 may be mounted on it or affixed to it upwardly.

System 100 may further comprise one or more other User Interface (UI) elements 116, such as buttons, sliders, switches, or the like, which may be implemented as mechanical elements and/or physical elements and/or as electronic elements and/or as Graphic UI (GUI) elements via a digital GUI unit (e.g., not necessarily a computer screen or monitor; but rather, a small-size digital panel which may be the size of approximately 8×4 centimeters, similar to a GUI panel of a microwave oven or that of a portable audio player). Such UI elements 116 may enable a user (e.g., a player, or an administrator) to modify one or more operational properties of the system 100; for example, an on/off button or switch to turn the system on and off; a volume slider to regulate or modify the level of volume that is produced by the audio speakers; an illumination intensity/brightness slider to regular or modify the illumination intensity or illumination brightness level of the illumination units; a mute/un-mute button to rapidly mute the entire audio of the entire system and to un-mute it; a pause button to pause and un-pause the entire operation of the device, or to temporarily freeze it and unfreeze it; a reset button to cause the system to reset an ongoing operational mode or game and to reset to a particular initial status; or the like. Particularly, a Mode Selector 117 may be included, as a physical or mechanical switch or pin or slider or selector unit, or as an electronic or digital selection unit (e.g., using one or more of the touch-sensors), to enable a user to select and/or modify the gaming mode or operational mode that would govern the operation of the system.

Optionally, a Coin-Op/Payment Unit 118 may operate to receive payment from user(s), as a requirement for starting (or continuing) a particular game or operational mode; for example, by receiving and counting coins and/or bills of money, by receiving and counting game tokens or game tickets, by receiving payment via a credit card or debit card or from a payment module of a smartphone (e.g., Apple Pay, Google Pay, Samsung Pay, or the like), by reading or scanning a barcode or QR code or a magnetic strip or a magnetic card that indicates that its user has a credit balance of money or of playable games or rounds, or the like. In some embodiments, the gaming device may be provided to a venue or an establishment (e.g., a restaurant, a bar, a pub, a shopping center, a shopping mall, a conference center, or the like) for free; or may be rented or leased on a time-slot basis (e.g., on an hourly or daily or weekly or monthly basis). In some embodiments, the gaming device may comprise an internal counter, able to count the number of games played and/or the number of minutes played and/or the number of end-users that played; and the data collected and monitored by such counter may be used to charge the venue on a per-minute basis or per-game basis or per-player basis; for example, enabling the owner of the gaming system to lease it to a venue, that will pay, for example, D cents per each minute of game that was played, and/or G dollars for each game that was played, and/or P dollars for each end-user that played. In some embodiments, such fees or payments may optionally be collected from the venue operator, and/or from end-user(s) that play with the gaming device itself. In some embodiments, other types of subscription models may be used; for example, the venue operator may rent the gaming device for a fixed weekly or monthly price, and may also pay to the owner of the gaming device for maintenance or repair services, or for upgrade services, or the like. In some embodiments, payment may be collected from one or more of the end-users that play with the gaming device, for example, via said payment module of the gaming device, and/or by swiping or tapping a credit card or debit card or other payment instrument, and/or by utilizing a mobile payment mechanism or smartphone-based payment system such as Apple Pay or Google Pay or Samsung Pay, or via other suitable payment mechanisms. In some embodiments, the gaming device may comprise the suitable circuitry to block or prevent the gaming device from enabling game-play, unless or until payment was collected from end-users and/or from the operator of the venue. In some embodiments, optionally, payment by the end-user may cause the gaming device to be playable for a pre-defined time period; for example, payment of 1 dollars may cause the gaming device to be playable for three minutes; or the like. Other suitable pricing schemes and payment collection methods may be used.

An enrollment unit 119 operates to enroll users to be players in a fresh round or game that is commencing. For example, as described above, an enrollment stage may be performed, in which an illuminated animation depicts a ring of light that descends slowly (e.g., within ten seconds) along the central pole 102, such that users join the new game by tapping or touching touch-sensors during the enrollment stage; and the numbers of users that enrolled via such touches during the limited-time enrollment stage, are registered as the active players for the game (or round) that starts upon completion of the enrollment stage.

A game logic executor 120, which may be part of the processor 104 or may be a separate unit or module, operates to apply the instructions or code that cause the system to execute a particular game or a particular logic of operations or rules or gaming rules or operational rules. For example, storage unit 106 or a Game Logic Bank 136 may store several Game Logic items, each one of them comprising instructions and/or data for a different game that is playable via the system 100; and based on the current status or the most-recent selection done via the Mode Selector 117, the processor 104 obtains or reads or utilizes the relevant Game Logic from the storage unit 104, and the game logic executor 120 performs the actual operations as dictated in that Game Logic; for example: activate a particular illumination unit for a particular time-length; de-activate a particular illumination unit; output a particular sound effect at a particular audio speaker; check whether within T milliseconds of an illumination event there was a touch-even registered at a particular touch-sensor; perform a particular action if the check result is positive; perform a particular action if the check result is negative; update, increase or decrease values of accumulators or variables that track current scores or current progress of active players; check whether a winning condition holds true, and perform operations associated with a winning situation; check whether a loss condition or a fail condition or a tie condition hold true, and perform operations associated with such situations; check whether an allocated time-period has elapsed, optionally using a Real-Time Clock (RTC) 121 or other time-monitoring unit (e.g., based on a clock of the processor 104, or based on counting processor cycles, or the like); and/or cause the performance of other suitable game-related operations based on the current Game Logic being used.

In some embodiments, the Game Logic or other rules that are executed by the Game Logic Executor 120, may dictate a deterministic or pre-defined pattern or series of illumination events and/or their respective touch-events that are required to be performed in response to such illumination events; for example, based on a pre-defined list of such illumination events and/or required responses, or based on a particular list from a bank or pool or repository of multiple such pre-defined lists. In other embodiments, the Game Logic or other rules that are executed by the Game Logic Executor 120, may follow a non-deterministic route which may include random or pseudo-random elements; for example, using rules such as, “select randomly one set of illumination units and illuminate it”, or “select randomly one color out of the four colors of players that are now playing, and illuminate only the illumination units that require that randomly-selected player to respond”, or other selection criteria or events that may be based, in whole or in part, or random or pseudo-random component. The random or pseudo-random selection of such parameters may be performed by the Game Logic Executor 120 or by the processor 104 by optionally utilizing a Random Number Generator (RNG) unit 129 or a pseudo-random number generator (PRNG) or other suitable mechanism.

In some embodiments, optionally, a Score Tracker Unit 122 may handle the monitoring and updating of the scores or progress of the user(s), by updating and/or increasing and/or decreasing values of parameters that track their scores or progress, based on completed touch-events or based on other criteria. Optionally, a Leader/Winner Determination Unit 123 may operate to check (e.g., periodically, or every T milliseconds, or upon every new touch event, or at pre-defined time intervals, or upon elapsing of an overall game period) whether or not a particular player, or a set of particular players, are to be declared as winners or as leaders; for example, by comparing the scores or the final scores of players and identifying the player having the highest score as well as the color associated with that player. In some embodiments, some data, such as the highest score achieved, may be stored on non-volatile memory (e.g., Flash memory card, memory stick, hard disk drive, solid state drive, or the like) which maintains the stored data even if the gaming device is powered off, thereby enabling the gaming device to “remember” and retrieve the high score for long period of time without dependency on being connected to a power outlet. Optionally, a Prize Dispenser Unit 124 may then operate to dispense or provide or output a prize or reward to the identified winner(s); for example, money or money equivalents (e.g., in jurisdictions that legally allow the gaming device to reward players with money or money equivalents), tokens, reward tickets, additional gaming tokens, credit for additional games in this system or in other gaming systems, discount coupons, a printed receipt or other article (e.g., a barcode or QR code that is sent to the winner's smartphone via email or text message) that entitles the winner to receive a tangible prize or a non-tangible prize (e.g., virtual money or virtual points or other virtual items), or the like.

In some embodiments, system 100 may optionally comprise one or more audio microphones 125 able to capture or acquire sounds, speech, utterances, ambient noise, or other audio from the environment in which the system is located and/or from users or players or other persons near it. For example, a speech-to-text converter 126 and/or an Automatic Speech Recognition (ASR) unit 127 may convert captured audio into identified speech elements or commands segments, which may be provided to a Voice Control Unit 128 which matches such identified speech segments with pre-defined commands that are then executed and modify the operational properties of the system. For example, the Voice Control Unit 128 may be responsive to identification of particular voice commands such as “increase the volume” or “mute the game” or “start new game” or “switch to single-player mode”, and may generate or pass appropriate signals or commands to other units of the system 100, directly and/or via the processor 104 and/or via other units or modules.

Optionally, system 100 may comprise one or more motion sensors 129 or other suitable sensors (e.g., proximity sensors, LIDAR sensors, camera, imagers), able to sense the presence and/or motion and/or gestures of persons located around or near the system 100 or passing nearby; for example, in order to trigger an audible invitation for such persons to start or join a game, or in order to trigger selective activation of illumination units and/or selective generation of sounds in response to such motion of users or persons near the system. For example, the processor 104 may be programmed or configured such that when the system is in idle mode, and no game is taking place, the motion sensors 129 or some of them will continuously scan or sense the surrounding of the system 100 and will generate an audible invitation or a visible invitation to start a game upon detection or sensing of one or more person walking nearby or lingering next to the system for at least T seconds.

System 100 may optionally comprise one or more means for wired communication and/or wireless communication; for example, a Wi-Fi transceiver 131 (e.g., an IEEE 802.11 transceiver), a Bluetooth transceiver 132, a cellular transceiver 133 (e.g., a 3G or 4G or 4G-LTE or 5G transceiver), a communication port 134 (e.g., USB port, micro-USB port, mini-USB port, USB Type-C port, or the like), or other suitable communication interface elements (e.g., modem, Network Interface Card (NIC), or the like); which may enable the system 100 to communicate with external devices and/or remote servers; for example, in order to receive indication that a payment was made for a game to start, or to provide a signal that a user is entitled for a reward, or to receive commands from an owner or operator of the system with regard to its operational properties (e.g., a remote command to turn-off the entire system, or to switch it into sleep mode, or to switch it back from sleep mode to an operational mode, or to commence or stop a particular presentation pattern through the system), or to receive updates or modifications or upgrades or additions to data or instructions or code or Game Logic that are stored in the storage unit 106 and that are then executed by the units and modules of the system 100. Optionally, a programming interface 135 or an Application Programming Interface (API) or other mechanism may be used to enable an owner or operator of the system, or a third-party developer, to perform and provide such updates or modifications.

In some embodiments, the gaming device or its table-top surface may be structured or formed or constructed as a monolithic device; such that, for example, the touch-sensitive surfaces (or touch-based sensors), as well as the strips or the rows of illumination units, as well as the table portions that are between them, are all implemented as a single sturdy platform or table-top. In some embodiments, optionally, modular construction may be utilized, and may enable “hot swap” or “cold swap” of component(s), to facilitate and/or to reduce costs of repair and maintenance, or to facilitate and/or reduce costs of replacing a particular portion or region of the gaming device that is faulty or that requires replacement or maintenance. For example, in a demonstrative implementation, the gaming device may be constructed as having 12 separate replaceable and/or removable and/or detachable touch-based sensors; such that, for example, if touch-based sensor 151 becomes defective or faulty, then it may be detached from its mechanical/electrical connector and be rapidly replaced with a replacement sensor which can fit instead of any one of the 12 touch-based sensors. Similarly, additionally or alternatively, the strips of illumination units may be divided into 12 regions or segments, each one of them being replaceable or removable or detachable by itself; such that, for example, if region 171 becomes defective or faulty, then only this particular region of the gaming device (with its integrated illumination units) may be pulled out or detached from its electrical/mechanical connectors, and be replaced with a substitute region having the same size, structure, and illumination units. Accordingly, the gaming device may be constructed in a module way, from 12 replaceable input (touch-based) units and 12 other replaceable output (illumination) units, which may all be interconnected through mechanical and/or electrical connectors; and which, in turn, may be connected to the processor and memory unit and other units of the gaming device; and which may allow efficient and/or rapid and/or reduced-cost repair or replacement or maintenance of a faulty components; without the need to ship the entirety of the gaming device to a service location, and/or without the need to take apart the gaming device using a screwdriver and other tools. Other suitable structures may be used.

Reference is made to FIG. 1C, which is a schematic perspective illustration of a system 100C, in accordance with some demonstrative embodiments of the present invention; and also to FIG. 1D, which is a schematic perspective illustration of a system 100D, in accordance with some demonstrative embodiments of the present invention. System 100D of FIG. 1D is shown with the central pole 102; whereas system 100C of FIG. 1C is shown without such central pole, since the gaming device of the present invention may optionally operate without such central pole. Systems 100C and 100D may be particular implementations of system 100 discussed above. For demonstrative purposes, four legs 103 are shown in system 100C and 100D, although these systems may be implemented using three legs and/or using a central (e.g., wider) leg. The Applicants have also realized that although a table having three legs typically never rocks and is always balanced, an implementation having four legs (and not three legs) may provide increases stability and endurance to the particular gaming system of the present invention, since human users touch or push the table as the interact with it, and in order to avoid the table from tipping-over or even from breaking if a user hits the table too harshly; accordingly, in some embodiments it may be particularly advantageous to utilize four supporting legs and not three.

Reference is made to FIG. 1E, which is a schematic perspective illustration of a system 100E surrounded by (and engaged with) two human players, in accordance with some demonstrative embodiments of the present invention. System 100E may be a particular implementation of system 100 discussed above. For demonstrative purposes, two adult players are shown; however, other number of player(s) may engage with the system, and they may be of different ages or age-groups. In some embodiments, a typical human player is required to (at least) fully stretch or fully extend his arm, in order to effectively reach a touch-sensor located at a far end of the table opposite to the player's location; or may be needed to run around the table in order to touch that touch-sensor; thereby ensuring that the gaming system of the present invention is not treated as a hand-held or portable device in which only fingers move while the entire body is at rest, but rather, an entire-body physical motion may be required in order to convey particular touch-gestures to the gaming system of the present invention. In some embodiments, it is possible that two (or more) players that play with the same system, against each other or in cooperation with each other or as teams, may sometimes collide or almost-collide with each other's arm or hand; for example, user Adam may reach with his arm to tap on a first touch-based sensor, and may collide in mid-air, or may pass in close proximity to, the hand or arm of user Cathy who may be reaching with her arm towards a second touch-based sensor; and in some embodiments, the possibility of such mid-air collisions or “near miss” events, may be part of the added fun and social interaction among the players. In some embodiments, optionally, a game may be configured to eliminate or to significantly reduce the possibility of such real-life arm or hand collisions; for example, in a gaming mode in which user Adam needs to tap particularly touch-based sensors number 1 through 6 which are closer to his location, whereas user Cathy needs to tap particularly touch-based sensors number 7 through 12 which are closer to her location, thereby reducing or eliminating the possibility for such physical collisions, if desired.

In some embodiments, one version of the gaming device may have size and dimensions that are more suitable for adult players (e.g., diameter of 70 or 75 or 80 or 85 or 90 or 95 or 100 centimeters; or diameter of at least 70 centimeters), requiring an adult to fully stretch his arm in order to reach a touch-sensor located at an opposite side of the gaming device; whereas, another version of the gaming device may have size and dimensions that are more suitable for children (e.g., diameter of under 70 centimeters; or diameter of 65 or 60 or 55 or 50 centimeters), requiring a child to fully stretch his arm in order to reach a touch-sensor located at an opposite side of the gaming device. Other suitable versions or dimensions may be used.

In some embodiments, the playing surface or the upper surface of the gaming device may have particular dimensions or sizes, which the Applicant have realized to be advantageous or beneficial for utilization of the gaming device by a variety of age-groups. For example, in some embodiments, the diameter of the playing surface and/or of the gaming device may be 70 or 75 or 80 or 85 or 90 or 95 or 100 centimeters; or may be at least 70 or at least 75 or at least 80 or at least 85 or at least 90 centimeters; or other suitable values or ranges. In some embodiments, for example, the height of the top surface of the playing surface, relative to the floor or the ground, may be 100 or 95 or 90 or 85 or 80 or 75 centimeters, or may be approximately 70 or 65 or 60 or 55 or 50 or 45 or 40 centimeters in order to accommodate shorter persons and/or disabled persons and/or children. In some embodiments, the leg or legs of the gaming device may have adjustable height, using a telescopic mechanism, or using a folding mechanism, or using a threading or screwing mechanism, or using a mechanism that enables to add or to remove extensions or portions of the leg(s). In some embodiments, the central pole may have, for example, height of approximately 30 or 35 or 40 or 45 or 50 or 55 or 60 or 65 or 70 centimeters, or other suitable values. In some embodiments, the height of the central pole may be, for example, approximately 40% or 45% or 50% or 55% or 60% of the diameter of the playing surface, or may be in the range of 40 to 60 percent of the diameter of the playing surface, or may be in the range of 33 to 66 percent of the diameter of the playing surface; other suitable values or ranges may be used. In some embodiments, the diameter or thickness of the central pole may be, for example, 3 or 4 or 5 or 6 or 7 centimeters; other suitable values may be used. In some embodiments, the thickness or the height of the playing surface by itself, may be for example 2 or 3 or 4 or 5 or 6 or 7 or 10 centimeters; as the playing surface may optionally encapsulate or store therein one or more (or some, or all) of the components or units of the gaming device, and/or such units may be connected underneath the playing surface. Other suitable arrangements may be used.

Some embodiments include a system comprising: a table top, having embedded therein (i) a plurality of illumination units and also (ii) a plurality of touch-sensitive surfaces; wherein the plurality of illumination units comprises at least: (i) a first illumination unit that is capable of illuminating, selectively, in different illumination colors at different time-slots; (ii) a second illumination unit that is capable of illuminating, selectively, in different illumination colors at different time-slots. The plurality of touch-sensitive surfaces comprises at least: (I) a first touch-sensitive surface that is located at a first location of said table top; (II) a second touch-sensitive surface that is located at a second location of said table top which is opposite to said first location. The system further comprises a hardware processor configured to execute a pre-defined logic which causes (A) selective illumination of a particular illumination unit at a particular illumination color, (B) checking whether a user who is pre-enrolled with said particular color, has touched a particular touch-sensitive surface that is temporarily and non-fixedly associated with said particular illumination unit.

In some embodiments, the hardware processor is configured to execute a pre-defined logic of a game for N users, wherein N is a positive integer; wherein each particular illumination unit is configured by said processor to illuminate at a first color, then to illuminate at a second color, then to be non-illuminated, and then to be illuminated in either the first color or the second color.

In some embodiments, the processor enforces an operational logic in which: (i) a first touch on a particular touch-sensitive surface immediately causes generation of a first sound; and (ii) subsequently, a second touch on said particular touch-sensitive surface immediately causes generation of a second, different, sound.

In some embodiments, the processor enforces an operational logic in which: (i) a first touch on a particular touch-sensitive surface immediately causes a particular illumination unit to illuminate in a first color; and (ii) subsequently, a second touch on said particular touch-sensitive surface immediately causes said particular illumination unit to illuminate in a second, different, color.

In some embodiments, each one of the illumination units is only temporarily and non-fixedly associated with any particular touch-sensitive surface; wherein each one of the touch-sensitive surfaces is only temporarily and non-fixedly associated with any particular illumination unit; wherein the processor enforces a temporary and dynamically-changing association between one or more illumination units and one particular touch-sensitive surface.

In some embodiments, each one of the touch-sensitive surfaces is located at a horizontal displacement (or offset) relative to any one of the illumination units; wherein none of the touch-sensitive surface is located vertically or exactly vertically under or below or beneath any of said illumination units.

In some embodiments, each one of the touch-sensitive surfaces is at least partially surrounded by a pattern of illumination units that, when illuminated by a particular color, indicate to users of the system that only a user that is associated with said particular color is required to rapidly touch said touch-sensitive surface.

In some embodiments, the table top has a longest physical dimension (e.g., its length dimension; or its diameter; or its longest diagonal) that requires a human user, who stands at a first spatial point in proximity to the table top, to physically extend his arm in its entirety across the table top in order to reach a touch-sensitive surface that is located at a table top region that is opposite said first spatial point.

In some embodiments, the system includes an enrollment unit which comprises a string of illumination units, arranged in a pre-defined pattern from an initial illumination unit to a final illumination unit; wherein the enrollment unit causes the illumination units to selectively illuminate and display a running light within a pre-defined time-limited enrollment period; wherein the enrollment unit determines a value of P which is a positive integer that indicates the number of different touch-sensitive surfaces that were touched by users during the pre-defined time-limited enrollment period; wherein, upon elapsing of the pre-defined time-limited enrollment period, the enrollment unit is to initiate a new game that is playable on said system by exactly P players.

In some embodiments, the system includes at least one audio speaker to generate a first audible sound indicating a correct user gesture, and to generate a second, different, audible sound indicating an incorrect user gesture.

In some embodiments, the system includes a central pole which extends vertically and perpendicularly to a center of the table top; wherein the central pole comprises a set of illumination units that are controlled via selective illumination to indicate at least one or more correct user-gestures performed via the touch-sensitive surfaces.

In some embodiments, the system is a table which comprises a single central leg that is connected perpendicularly and vertically underneath said table top, which causes said table top to stand fixedly at approximately waist-level of human users; wherein the table top has a form factor that requires at least one human user to completely extend his arm in order to touch a touch-sensitive surface that is located at an opposite location of the table top relative to the location in which said one human user stands.

In some embodiments, the system is a table which comprises three or more legs that are connected perpendicularly and vertically underneath said table top, which cause said table top to stand fixedly at approximately waist-level of human users; wherein the table top has a form factor that requires at least one human user to completely extend his arm in order to touch a touch-sensitive surface that is located at an opposite location of the table top relative to the location in which said one human user stands.

In some embodiments, the system includes: at least one audio speaker to generate a first audible sound indicating a correct user gesture, and to generate a second, different, audible sound indicating an incorrect user gesture; a mute/unmute switch, to selectively mute and unmute sounds of the at least one audio speaker; wherein the mute/unmute switch is implemented as a mechanical switch or as a digital user interface element; wherein the system continues to output a playable game of illumination and touch events that is fully playable and is fully comprehensible to human users even when the audio output of the system is entirely muted.

In some embodiments, the hardware processor is configured to perform, or to command, or to trigger, or to cause performance of: (A) selective illumination of a first particular illumination unit at a first particular color; (B) checking whether a first particular touch-sensitive surface is touched by any user within a pre-defined time-period in which said first particular illumination unit is lit at said first particular color; (C) increasing a first score that is associated with said first particular color if the checking of step (B) has a positive result; (D) selective illumination of a second particular illumination unit at a second particular color; (E) checking whether a second particular touch-sensitive surface is touched by any user within a pre-defined time-period in which said second particular illumination unit is lit at said second particular color; (F) increasing a second score that is associated with said second particular color if the checking of step (E) has a positive result.

In some embodiments, the system includes: a wireless transceiver to receive updates to game logic that is stored in a game logic bank of said system; wherein the processor is to write said updates into said game logic bank.

In some embodiments, the system includes: a wireless transceiver to receive an incoming wireless communication signal indicating a command to modify an operational property of said system; wherein the processor is to execute, based on said incoming wireless communication signal, said command to modify said operational property of said system.

In some embodiments, the system includes: a motion sensor to sense that a person is passing within a pre-defined proximity to said table top, and to trigger an audio speaker of the system to generate an audible invitation message which invites said person to join a game playable via said table top.

In some embodiments, the system includes: at least one fingerprint scanner, to enroll one or more players based on fingerprint scanning, and to enforce a gaming rule that requires that only a particular player that has a particular fingerprint would touch a particular touch-sensitive surface.

Some embodiments include a gaming table comprising: said table top, having embedded therein (i) a plurality of illumination units and also (ii) a plurality of touch-sensitive surfaces; one or more table legs that support the table top at waist level of one or more human users.

Although portions of the discussion herein relate, for demonstrative purposes, to wired links and/or wired communications, some embodiments of the present invention are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments of the present invention may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

The present invention may be implemented by using code or program code or machine-readable instructions or machine-readable code, which is stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such device to perform a method in accordance with the present invention.

The system(s) and/or device(s) of the present invention may optionally comprise, or may be implemented by utilizing suitable hardware components and/or software components; for example, processors, processor cores, Central Processing Units (CPUs), Digital Signal Processors (DSPs), circuits, Integrated Circuits (ICs), controllers, memory units, registers, accumulators, storage units, input units (e.g., touch-screen, keyboard, keypad, stylus, mouse, touchpad, joystick, trackball, microphones), output units (e.g., screen, touch-screen, monitor, display unit, audio speakers), acoustic microphone(s) and/or sensor(s), optical microphone(s) and/or sensor(s), laser or laser-based microphone(s) and/or sensor(s), wired or wireless modems or transceivers or transmitters or receivers, GPS receiver or GPS element or other location-based or location-determining unit or system, network elements (e.g., routers, switches, hubs, antennas), and/or other suitable components and/or modules.

The system(s) and/or devices of the present invention may optionally be implemented by utilizing co-located components, remote components or modules, “cloud computing” servers or devices or storage, client/server architecture, peer-to-peer architecture, distributed architecture, and/or other suitable architectures or system topologies or network topologies.

In accordance with embodiments of the present invention, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL, BASIC, Visual BASIC, Matlab, Pascal, HTML, HTML5, CSS, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

Some embodiments of the present invention may perform steps or operations such as, for example, “determining”, “identifying”, “comparing”, “checking”, “querying”, “searching”, “matching”, and/or “analyzing”, by utilizing, for example: a pre-defined threshold value to which one or more parameter values may be compared; a comparison between (i) sensed or measured or calculated value(s), and (ii) pre-defined or dynamically-generated threshold value(s) and/or range values and/or upper limit value and/or lower limit value and/or maximum value and/or minimum value; a comparison or matching between sensed or measured or calculated data, and one or more values as stored in a look-up table or a legend table or a list of reference value(s) or a database of reference values or ranges; a comparison or matching or searching process which searches for matches and/or identical results and/or similar results and/or sufficiently-close results, among multiple values or limits that are stored in a database or look-up table; utilization of one or more equations, formula, weighted formula, and/or other calculation in order to determine similarity or a match between or among parameters or values; utilization of comparator units, lookup tables, threshold values, conditions, conditioning logic, Boolean operator(s) and/or other suitable components and/or operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Repeated use of the phrase “in one embodiment” does not necessarily refer to the same embodiment, although it may. Repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may comprise, or may be implemented by using, an “app” or application which may be downloaded or obtained from an “app store” or “applications store”, for free or for a fee, or which may be pre-installed on a computing device or electronic device, or which may be transported to and/or installed on such computing device or electronic device.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may comprise any possible combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of the present invention have been illustrated and described herein, many modifications, substitutions, changes, and equivalents may occur to those skilled in the art. Accordingly, the claims are intended to cover all such modifications, substitutions, changes, and equivalents.

1. A system comprising:
a table top, having embedded therein (i) a plurality of illumination units and also (ii) a plurality of touch-sensitive surfaces;
wherein the plurality of illumination units comprises at least:
(i) a first illumination unit that is capable of illuminating, selectively, in different illumination colors at different time-slots;
(ii) a second illumination unit that is capable of illuminating, selectively, in different illumination colors at different time-slots;
wherein the plurality of touch-sensitive surfaces comprises at least:
(I) a first touch-sensitive surface that is located at a first location of said table top;
(II) a second touch-sensitive surface that is located at a second location of said table top which is opposite to said first location;
wherein the system further comprises a hardware processor configured to execute a pre-defined logic which causes (A) selective illumination of a particular illumination unit at a particular illumination color, (B) checking whether a user who is pre-enrolled with said particular color, has touched a particular touch-sensitive surface that is temporarily and non-fixedly associated with said particular illumination unit.

2. The system of claim 1,
wherein the hardware processor is configured to execute a pre-defined logic of a game for N users, wherein N is a positive integer,
wherein each particular illumination unit is configured by said processor to illuminate at a first color, then to illuminate at a second color, then to be non-illuminated, and then to be illuminated in either the first color or the second color.

3. The system of claim 1,
wherein the processor enforces an operational logic in which: (i) a first touch on a particular touch-sensitive surface immediately causes generation of a first sound; and (ii) subsequently, a second touch on said particular touch-sensitive surface immediately causes generation of a second, different, sound.

4. The system of claim 1,
wherein the processor enforces an operational logic in which: (i) a first touch on a particular touch-sensitive surface immediately causes a particular illumination unit to illuminate in a first color; and (ii) subsequently, a second touch on said particular touch-sensitive surface immediately causes said particular illumination unit to illuminate in a second, different, color.

5. The system of claim 1,
wherein each one of the illumination units is only temporarily and non-fixedly associated with any particular touch-sensitive surface;
wherein each one of the touch-sensitive surfaces is only temporarily and non-fixedly associated with any particular illumination unit;
wherein the processor enforces a temporary and dynamically-changing association between one or more illumination units and one particular touch-sensitive surface.

6. The system of claim 1,
wherein each one of the touch-sensitive surfaces is located at a horizontal displacement relative to any one of the illumination units;
wherein none of the touch-sensitive surface is located vertically under any of said illumination units.

7. The system of claim 1,
wherein each one of the touch-sensitive surfaces is at least partially surrounded by a pattern of illumination units that, when illuminated by a particular color, indicate to users of the system that only a user that is associated with said particular color is required to rapidly touch said touch-sensitive surface.

8. The system of claim 1,
wherein the table top has a longest physical dimension that requires a human user, who stands at a first spatial point in proximity to the table top, to physically extend his arm in its entirety across the table top in order to reach a touch-sensitive surface that is located at a table top region that is opposite said first spatial point.

9. The system of claim 1, further comprising:
an enrollment unit which comprises a string of illumination units, arranged in a pre-defined pattern from an initial illumination unit to a final illumination unit;
wherein the enrollment unit causes the illumination units to selectively illuminate and display a running light within a pre-defined time-limited enrollment period;
wherein the enrollment unit determines a value of P which is a positive integer that indicates the number of different touch-sensitive surfaces that were touched by users during the pre-defined time-limited enrollment period;
wherein, upon elapsing of the pre-defined time-limited enrollment period, the enrollment unit is to initiate a new game that is playable on said system by exactly P players.

10. The system of claim 1, further comprising:
at least one audio speaker to generate a first audible sound indicating a correct user gesture, and to generate a second, different, audible sound indicating an incorrect user gesture.

11. The system of claim 1, further comprising:
a central pole which extends vertically and perpendicularly to a center of the table top;
wherein the central pole comprises a set of illumination units that are controlled via selective illumination to indicate at least one or more correct user-gestures performed via the touch-sensitive surfaces.

12. The system of claim 1,
wherein the system is a table which comprises a single central leg that is connected perpendicularly and vertically underneath said table top, which causes said table top to stand fixedly at approximately waist-level of human users;
wherein the table top has a form factor that requires at least one human user to completely extend his arm in order to touch a touch-sensitive surface that is located at an opposite location of the table top relative to the location in which said one human user stands.

13. The system of claim 1,
wherein the system is a table which comprises three or more legs that are connected perpendicularly and vertically underneath said table top, which cause said table top to stand fixedly at approximately waist-level of human users;
wherein the table top has a form factor that requires at least one human user to completely extend his arm in order to touch a touch-sensitive surface that is located at an opposite location of the table top relative to the location in which said one human user stands.

14. The system of claim 1, further comprising:
at least one audio speaker to generate a first audible sound indicating a correct user gesture, and to generate a second, different, audible sound indicating an incorrect user gesture;
a mute/unmute switch, to selectively mute and unmute sounds of the at least one audio speaker;
wherein the mute/unmute switch is implemented as a mechanical switch or as a digital user interface element;
wherein the system continues to output a playable game of illumination and touch events that is fully playable and is fully comprehensible even when the audio of the system is entirely muted.

15. The system of claim 1,
wherein the hardware processor is configured to perform or to cause performance of:
(A) selective illumination of a first particular illumination unit at a first particular color;
(B) checking whether a first particular touch-sensitive surface is touched by any user within a pre-defined time-period in which said first particular illumination unit is lit at said first particular color;
(C) increasing a first score that is associated with said first particular color if the checking of step (B) has a positive result;
(D) selective illumination of a second particular illumination unit at a second particular color;
(E) checking whether a second particular touch-sensitive surface is touched by any user within a pre-defined time-period in which said second particular illumination unit is lit at said second particular color;
(F) increasing a second score that is associated with said second particular color if the checking of step (E) has a positive result.

16. The system of claim 1, further comprising:
a wireless transceiver to receive updates to game logic that is stored in a game logic bank of said system;
wherein the processor is to write said updates into said game logic bank.

17. The system of claim 1, further comprising:
a wireless transceiver to receive an incoming wireless communication signal indicating a command to modify an operational property of said system;
wherein the processor is to execute, based on said incoming wireless communication signal, said command to modify said operational property of said system.

18. The system of claim 1, further comprising:
a motion sensor to sense that a person is passing within a pre-defined proximity to said table top, and to trigger an audio speaker of the system to generate an audible invitation message which invites said person to join a game playable via said table top.

19. The system of claim 1, further comprising:
at least one fingerprint scanner, to enroll one or more players based on fingerprint scanning, and to enforce a gaming rule that requires that only a particular player that has a particular fingerprint would touch a particular touch-sensitive surface.

20. A gaming table comprising:
a table top, having embedded therein (i) a plurality of illumination units and also (ii) a plurality of touch-sensitive surfaces;
one or more table legs that support the table top at waist level of one or more human users;
wherein the plurality of illumination units comprises at least:
(i) a first illumination unit that is capable of illuminating, selectively, in different illumination colors at different time-slots;
(ii) a second illumination unit that is capable of illuminating, selectively, in different illumination colors at different time-slots;
wherein the plurality of touch-sensitive surfaces comprises at least:
(I) a first touch-sensitive surface that is located at a first location of said table top;
(II) a second touch-sensitive surface that is located at a second location of said table top which is opposite to said first location;
wherein the system further comprises a hardware processor configured to execute a pre-defined logic which causes (A) selective illumination of a particular illumination unit at a particular illumination color, (B) checking whether a user who is pre-enrolled with said particular color, has touched a particular touch-sensitive surface that is temporarily and non-fixedly associated with said particular illumination unit.
